(19) United States
(12) Patent Application Publication
(10) Pub. No.: US 2016/0204838 A1
(43) Pub. Date: Jul. 14, 2016

(54) SIGNALING METHOD FOR COORDINATED MULTIPLE POINT TRANSMISSION AND RECEPTION, AND APPARATUS THEREFOR

(71) Applicant: LG ELECTRONICS INC., Seoul (KR)

(72) Inventors: Hanjun PARK, Seoul (KR); Kijun KIM, Seoul (KR); Jonghyun PARK, Seoul (KR); Hyungtae KIM, Seoul (KR); Hyunho LEE, Seoul (KR)

(73) Assignee: LG ELECTRONICS INC., Seoul (KR)

(21) Appl. No.: 14/913,245

(22) PCT Filed: Aug. 29, 2014
(86) PCT No.: PCT/KR2014/008069

§ 371 Date: Feb. 19, 2016

Related U.S. Application Data
(60) Provisional application No. 61/871,881, filed on Aug. 30, 2013.
(60) Provisional application No. 61/903,899, filed on Nov. 13, 2013.
(60) Provisional application No. 61/923,235, filed on Jan. 3, 2014.

(51) Int. Cl. H04B 7/02; H04W 72/12

(52) U.S. Cl. CPC H04B 7/024; H04W 72/1205

(57) ABSTRACT

Provided is a method for transmitting information for a coordinated multiple point transmission and reception (CoMP) operation, the method performed by a first evolved node B (eNB) and comprising: calculating a utility metric of a user equipment(s) (UE(s)) using a specific CoMP hypothesis; and transmitting the calculated utility metric and information about a CoMP hypothesis associated with the utility metric, to a second eNB, wherein the specific CoMP hypothesis comprises information about an eNB(s) hypothesized to perform specific-level power transmission among eNBs participating in the CoMP operation together with the first eNB.

### TECHNICAL FIELD

The present invention relates to a wireless communication system and, more particularly, to a signaling method for coordinated multiple point transmission and reception (CoMP), and an apparatus therefor.

### BACKGROUND ART

Recently, various devices requiring machine-to-machine (M2M) communication and high data transfer rate, such as smartphones or tablet personal computers (PCs), have appeared and come into widespread use. This has rapidly increased the quantity of data which needs to be processed in a cellular network. In order to satisfy such rapidly increasing data throughput, recently, carrier aggregation (CA) technology which efficiently uses more frequency bands, cognitive ratio technology, multiple antenna (MIMO) technology for increasing data capacity in a restricted frequency, multiple-base-station cooperative technology, etc. have been highlighted. In addition, communication environments have evolved such that the density of accessible nodes is increased in the vicinity of a user equipment (UE). Here, the node includes one or more antennas and refers to a fixed point capable of transmitting/receiving radio frequency (RF) signals to/from the user equipment (UE). A communication system including high-density nodes may provide a communication service of higher performance to the UE by cooperation between nodes.

A multi-node coordinated communication scheme in which a plurality of nodes communicates with a user equipment (UE) using the same time-frequency resources has much higher data throughput than legacy communication scheme in which each node operates as an independent base station (BS) to communicate with the UE without cooperation.

A multi-node system performs coordinated communication using a plurality of nodes, each of which operates as a base station or an access point, an antenna, an antenna group, a remote radio head (RRH), and a remote radio unit (RRU). Unlike the conventional centralized antenna system in which antennas are concentrated at a base station (BS), nodes are spaced apart from each other by a predetermined distance or more in the multi-node system. The nodes can be managed by one or more base stations or base station controllers which control operations of the nodes or schedule data transmitted/received through the nodes. Each node is connected to a base station or a base station controller which manages the node through a cable or a dedicated line.

The multi-node system can be considered as a kind of Multiple Input Multiple Output (MIMO) system since dispersed nodes can communicate with a single UE or multiple UEs by simultaneously transmitting/receiving different data streams. However, since the multi-node system transmits signals using the dispersed nodes, a transmission area covered by each antenna is reduced compared to antennas included in the conventional centralized antenna system. Accordingly, transmit power required for each antenna to transmit a signal in the multi-node system can be reduced compared to the conventional centralized antenna system using MIMO. In addition, a transmission distance between an antenna and a UE is reduced to decrease in pathloss and enable rapid data transmission in the multi-node system. This can improve transmission capacity and power efficiency of a cellular system and meet communication performance having relatively uniform quality regardless of UE locations in a cell. Further, the multi-node system reduces signal loss generated during transmission since base station(s) or base station controller(s) connected to a plurality of nodes transmit/receive data in cooperation with each other. When nodes spaced apart by over a predetermined distance perform coordinated communication with a UE, correlation and interference between antennas are reduced. Therefore, a high signal to interference-plus-noise ratio (SINR) can be obtained according to the multi-node coordinated communication scheme.

Owing to the above-mentioned advantages of the multi-node system, the multi-node system is used with or replaces the conventional centralized antenna system to become a new foundation of cellular communication in order to reduce base station cost and backhaul network maintenance cost while extending service coverage and improving channel capacity and SINR in next-generation mobile communication systems.

### DISCLOSURE

### Technical Problem

An object of the present invention devised to solve the problem lies on an efficient signaling method for (CoMP) between evolved node Bs (eNBs).

It is to be understood that both the foregoing general description and the following detailed description of the present invention are exemplary and explanatory and are intended to provide further explanation of the invention as claimed.

### Technical Solution

The object of the present invention can be achieved by providing a method for transmitting information for a coordinated multiple point transmission and reception (CoMP) operation, the method performed by a first evolved node B (eNB) and comprising calculating a utility metric of a user equipment(s) (UE(s)) using a specific CoMP hypothesis; and transmitting the calculated utility metric and information about a CoMP hypothesis associated with the utility metric, to a second eNB, wherein the specific CoMP hypothesis comprises information about an eNB(s) hypothesized to perform predetermined power-transmission among eNBs participating in the CoMP operation together with the first eNB.

Additionally or alternatively, the specific CoMP hypothesis may comprise a cell-identifier (ID) of the eNB(s) hypothesized to perform specific-level power transmission.

Additionally or alternatively, the utility metric may be calculated for every predetermined resource unit.

Additionally or alternatively, the utility metric may be a value for all user equipments (UEs) served by the first eNB.

Additionally or alternatively, the utility metric may be a value for a specific UE among all UEs served by the first eNB.

Additionally or alternatively, the utility metric may be expressed as a bit string, and one state expressed by the bit string represents that the first eNB rejects the CoMP operation.

In another aspect of the invention, provided is a method for transmitting information for a coordinated multiple point transmission and reception (CoMP) operation, the method performed by an evolved node B (eNB) and comprising receiving a utility metric of a user equipment(s) (UE(s)) calculated using a specific CoMP hypothesis from neighbor eNBs participating in the CoMP operation; scheduling the CoMP operation based on the received utility metric and information about a CoMP hypothesis associated with the utility metric; and transmitting a result of the scheduling to the neighbor eNBs, wherein the specific CoMP hypothesis comprises information about an eNB(s) hypothesized to perform predetermined power-transmission among the neighbor eNBs.

Additionally or alternatively, the specific CoMP hypothesis may comprise a cell-identifier (ID) of the eNB(s) hypothesized to perform specific-level power transmission.

Additionally or alternatively, the utility metric may be calculated for every predetermined resource unit.

Additionally or alternatively, the utility metric received from corresponding neighbor eNB may be a value for all user equipments (UEs) served by the corresponding neighbor eNB.

Additionally or alternatively, the utility metric received from corresponding neighbor eNB may be a value for a specific UE among all UEs served by the corresponding neighbor eNB.

Additionally or alternatively, the utility metric received from corresponding neighbor eNB may be expressed as a bit string, and one state expressed by the bit string represents that a corresponding neighbor eNB rejects the CoMP operation.

In another aspect of the invention, provided is an evolved node B (eNB) configured to transmit information for a coordinated multiple point transmission and reception (CoMP) operation, the eNB comprising a radio frequency (RF) unit; and a processor configured to control the RF unit, wherein the processor is configured to calculate a utility metric of a user equipment(s) (UE(s)) using a specific CoMP hypothesis, and transmit the calculated utility metric and information about a CoMP hypothesis associated with the utility metric, to a neighbor eNB, and wherein the specific CoMP hypothesis comprises information about a neighbor eNB(s) hypothesized to perform predetermined power-transmission among neighbor eNBs participating in the CoMP operation together with the eNB.

In another aspect of the invention, provided is an evolved node B (eNB) configured to transmit information for a coordinated multiple point transmission and reception (CoMP) operation, the eNB comprising a radio frequency (RF) unit; and a processor configured to control the RF unit, wherein the processor is configured to receive a utility metric of a user equipment(s) (UE(s)) calculated using a specific CoMP hypothesis from neighbor eNBs participating in the CoMP operation, schedule the CoMP operation based on the received utility metric and information about a CoMP hypothesis associated with the utility metric, and transmit a result of scheduling to the neighbor eNBs, and wherein the specific CoMP hypothesis comprises information about an eNB(s) hypothesized to perform predetermined power-transmission among the neighbor eNBs.

It is to be understood that both the foregoing general description and the following detailed description of the present invention are exemplary and explanatory and are intended to provide further explanation of the invention as claimed.

### Advantageous Effects

According to an embodiment of the present invention, information for CoMP may be efficiently transmitted and thus a high-quality communication environment may be expected through CoMP.

It will be appreciated by persons skilled in the art that that the effects that could be achieved with the present invention are not limited to what has been particularly described hereinabove and other advantages of the present invention will be more clearly understood from the following detailed description taken in conjunction with the accompanying drawings.

### DESCRIPTION OF DRAWINGS

The accompanying drawings, which are included to provide a further understanding of the invention, illustrate embodiments of the invention and together with the description serve to explain the principle of the invention. In the drawings:

FIG. 1 illustrates an exemplary structure of a radio frame used in a wireless communication system;

FIG. 2 illustrates an exemplary structure of a downlink/uplink (DL/UL) slot in a wireless communication system;

FIG. 3 illustrates an exemplary structure of a DL subframe used in the 3GPP LTE/LTE-A system;

FIG. 4 illustrates an exemplary structure of a UL subframe used in the 3GPP LTE/LTE-A system;

FIG. 5 illustrates an example of CoMP to which an embodiment of the present invention is applied;

FIG. 6 illustrates signaling according to an embodiment of the present invention;

FIG. 7 illustrates an example of data transmission information according to an embodiment of the present invention;

FIG. 8 illustrates an example of a data transmission information list according to an embodiment of the present invention;

FIG. 9 illustrates signaling according to an embodiment of the present invention;

FIG. 10 illustrates signaling according to an embodiment of the present invention;

FIG. 11 illustrates signaling according to an embodiment of the present invention;

FIG. 12 illustrates signaling according to an embodiment of the present invention;

FIG. 13 illustrates signaling according to an embodiment of the present invention;

FIG. 14 illustrates signaling according to an embodiment of the present invention;

FIG. 15 illustrates operation according to an embodiment of the present invention; and

FIG. 16 is a block diagram of an apparatus for implementing an embodiment(s) of the present invention.

### BEST MODE

Reference will now be made in detail to the preferred embodiments of the present invention, examples of which are illustrated in the accompanying drawings. The accompanying drawings illustrate exemplary embodiments of the present invention and provide a more detailed description of the present invention. However, the scope of the present invention should not be limited thereto.

In some cases, to prevent the concept of the present invention from being ambiguous, structures and apparatuses of the known art will be omitted, or will be shown in the form of a block diagram based on main functions of each structure and apparatus. Also, wherever possible, the same reference numbers will be used throughout the drawings and the specification to refer to the same or like parts.

In the present invention, a user equipment (UE) is fixed or mobile. The UE is a device that transmits and receives user data and/or control information by communicating with a base station (BS). The term ‘UE’ may be replaced with ‘terminal equipment’, ‘Mobile Station (MS)’, ‘Mobile Terminal (MT)’, ‘User Terminal (UT)’, ‘Subscriber Station (SS)’, ‘wireless device’, ‘Personal Digital Assistant (PDA)’, ‘wireless modem’, ‘handheld device’, etc. A BS is typically a fixed station that communicates with a UE and/or another BS. The BS exchanges data and control information with a UE and another BS. The term ‘BS’ may be replaced with ‘Advanced Base Station (ABS)’, ‘Node B’, ‘evolved-Node B (eNB)’, ‘Base Transceiver System (BTS)’, ‘Access Point (AP)’, ‘Processing Server (PS)’, etc. In the following description, BS is commonly called eNB.

In the present invention, a node refers to a fixed point capable of transmitting/receiving a radio signal to/from a UE by communication with the UE. Various eNBs can be used as nodes. For example, a node can be a BS, NB, eNB, pico-cell eNB (PeNB), home eNB (HeNB), relay, repeater, etc. Furthermore, a node may not be an eNB. For example, a node can be a radio remote head (RRH) or a radio remote unit (RRU). The RRH and RRU have power levels lower than that of the eNB. Since the RRH or RRU (referred to as RRH/RRU hereinafter) is connected to an eNB through a dedicated line such as an optical cable in general, cooperative communication according to RRH/RRU and eNB can be smoothly performed compared to cooperative communication according to eNBs connected through a wireless link. At least one antenna is installed per node. An antenna may refer to an antenna port, a virtual antenna or an antenna group. A node may also be called a point. Unlink a conventional centralized antenna system (CAS) (i.e. single node system) in which antennas are concentrated in an eNB and controlled an eNB controller, plural nodes are spaced apart at a predetermined distance or longer in a multi-node system. The plural nodes can be managed by one or more eNBs or eNB controllers that control operations of the nodes or schedule data to be transmitted/received through the nodes. Each node may be connected to an eNB or eNB controller managing the corresponding node via a cable or a dedicated line. In the multi-node system, the same cell identity (ID) or different cell IDs may be used for signal transmission/reception through plural nodes. When plural nodes have the same cell ID, each of the plural nodes operates as an antenna group of a cell. If nodes have different cell IDs in the multi-node system, the multi-node system can be regarded as a multi-cell (e.g. macro-cell/femto-cell/pico-cell) system. When multiple cells respectively configured by plural nodes are overlaid according to coverage, a network configured by multiple cells is called a multi-tier network. The cell ID of the RRH/RRU may be identical to or different from the cell ID of an eNB. When the RRH/RRU and eNB use different cell IDs, both the RRH/RRU and eNB operate as independent eNBs.

In a multi-node system according to the present invention, which will be described below, one or more eNBs or eNB controllers connected to plural nodes can control the plural nodes such that signals are simultaneously transmitted to or received from a UE through some or all nodes. While there is a difference between multi-node systems according to the nature of each node and implementation form of each node, multi-node systems are discriminated from single node systems (e.g. CAS, conventional MIMO systems, conventional relay systems, conventional repeater systems, etc.) since a plurality of nodes provides communication services to a UE in a predetermined time-frequency resource. Accordingly, embodiments of the present invention with respect to a method of performing coordinated data transmission using some or all nodes can be applied to various types of multi-node systems. For example, a node refers to an antenna group spaced apart from another node by a predetermined distance or more, in general. However, embodiments of the present invention, which will be described below, can even be applied to a case in which a node refers to an arbitrary antenna group irrespective of node interval. In the case of an eNB including an X-pole (cross polarized) antenna, for example, the embodiments of the preset invention are applicable on the assumption that the eNB controls a node composed of an H-pole antenna and a V-pole antenna.

A communication scheme through which signals are transmitted/received via plural transmit (Tx)/receive (Rx) nodes, signals are transmitted/received via at least one node selected from plural Tx/Rx nodes, or a node transmitting a downlink signal is discriminated from a node transmitting an uplink signal is called multi-eNB MIMO or CoMP (Coordinated Multi-Point Tx/Rx). Coordinated transmission schemes from among CoMP communication schemes can be categorized into JP (Joint Processing) and scheduling coordination. The former may be divided into JT (Joint Transmission)/JR (Joint Reception) and DPS (Dynamic Point Selection) and the latter may be divided into CS (Coordinated Scheduling) and CB (Coordinated Beamforming). DPS may be called DCS (Dynamic Cell Selection). When JP is performed, more various communication environments can be generated, compared to other CoMP schemes. JT refers to a communication scheme by which plural nodes transmit the same stream to a UE and JR refers to a communication scheme by which plural nodes receive the same stream from the UE. The UE/eNB combine signals received from the plural nodes to restore the stream. In the case of JT/JR, signal transmission reliability can be improved according to transmit diversity since the same stream is transmitted from/to plural nodes. DPS refers to a communication scheme by which a signal is transmitted/received through a node selected from plural nodes according to a specific rule. In the case of DPS, signal transmission reliability can be improved because a node having a good channel state between the node and a UE is selected as a communication node.

In the present invention, a cell refers to a specific geographical area in which one or more nodes provide communication services. Accordingly, communication with a specific cell may mean communication with an eNB or a node providing communication services to the specific cell. A downlink/uplink signal of a specific cell refers to a downlink/uplink signal from/to an eNB or a node providing communication services to the specific cell. A cell providing uplink/downlink communication services to a UE is called a serving cell. Furthermore, channel status/quality of a specific cell refers to channel status/quality of a channel or a communication link generated between an eNB or a node providing communication services to the specific cell and a UE. In 3GPP LTE-A systems, a UE can measure downlink channel state from a specific node using one or more CSI-RSs (Channel State Information Reference Signals) transmitted through antenna port(s) of the specific node on a CSI-RS resource allocated to the specific node. In general, neighboring nodes transmit CSI-RS resources on orthogonal CSI-RS resources. When CSI-RS resources are orthogonal, this means that the CSI-RS resources have different subframe configurations and/or CSI-RS sequences which specify subframes to which CSI-RSs are allocated according to CSI-RS resource configurations, subframe offsets and transmission periods, etc. which specify symbols and subcarriers carrying the CSI RSs.

In the present invention, PDCCH (Physical Downlink Control Channel)/PCFICH (Physical Control Format Indicator Channel)/PHICH (Physical Hybrid automatic repeat request Indicator Channel)/PDSCH (Physical Downlink Shared Channel) refer to a set of time-frequency resources or resource elements respectively carrying DCI (Downlink Control Information)/CFI (Control Format Indicator)/downlink ACK/NACK (Acknowlegement/Negative ACK)/downlink data. In addition, PUCCH (Physical Uplink Control Channel)/PUSCH (Physical Uplink Shared Channel)/PRACH (Physical Random Access Channel) refer to sets of time-frequency resources or resource elements respectively carrying UCI (Uplink Control Information)/uplink data/random access signals. In the present invention, a time-frequency resource or a resource element (RE), which is allocated to or belongs to PDCCH/PCFICH/PHICH/PDSCH/PUCCH/PUSCH/PRACH, is referred to as a PDCCH/PCFICH/PHICH/PDSCH/PUCCH/PUSCH/PRACH RE or PDCCH/PCFICH/PHICH/PDSCH/PUCCH/PUSCH/PRACH resource. In the following description, transmission of PUCCH/PUSCH/PRACH by a UE is equivalent to transmission of uplink control information/uplink data/random access signal through or on PUCCH/PUSCH/PRACH. Furthermore, transmission of PDCCH/PCFICH/PHICH/PDSCH by an eNB is equivalent to transmission of downlink data/control information through or on PDCCH/PCFICH/PHICH/PDSCH.

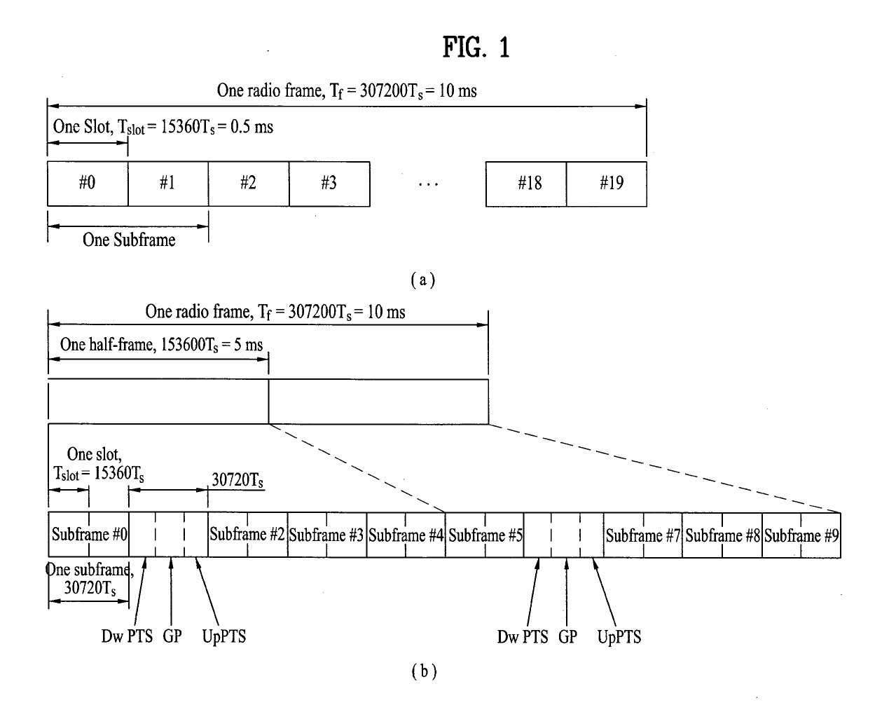

FIG. 1 illustrates an exemplary radio frame structure used in a wireless communication system. FIG. 1(a) illustrates a frame structure for frequency division duplex (FDD) used in 3GPP LTE/LTE-A and FIG. 1(b) illustrates a frame structure for time division duplex (TDD) used in 3GPP LTE/LTE-A.

Referring to FIG. 1, a radio frame used in 3GPP LTE/LTE-A has a length of 10 ms (307200 Ts) and includes 10 subframes in equal size. The 10 subframes in the radio frame may be numbered. Here, Ts denotes sampling time and is represented as Ts=1/(2048*15 kHz). Each subframe has a length of 1 ms and includes two slots. 20 slots in the radio frame can be sequentially numbered from 0 to 19. Each slot has a length of 0.5 ms. A time for transmitting a subframe is defined as a transmission time interval (TTI). Time resources can be discriminated by a radio frame number (or radio frame index), subframe number (or subframe index) and a slot number (or slot index).

The radio frame can be configured differently according to duplex mode. Downlink transmission is discriminated from uplink transmission by frequency in FDD mode, and thus the radio frame includes only one of a downlink subframe and an uplink subframe in a specific frequency band. In TDD mode, downlink transmission is discriminated from uplink transmission by time, and thus the radio frame includes both a downlink subframe and an uplink subframe in a specific frequency band.

Table 1 shows DL-UL configurations of subframes in a radio frame in the TDD mode.

TABLE 1

| | Downlink-to- | | | | | | | | | | |
|---|---|---|---|---|---|---|---|---|---|---|---|
| | Uplink | | | | | | | | | | |
| DL-UL | Switch-point | Subframe number | | | | | | | | | |
| configuration | periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

In Table 1, D denotes a downlink subframe, U denotes an uplink subframe and S denotes a special subframe. The special subframe includes three fields of DwPTS (Downlink Pilot TimeSlot), GP (Guard Period), and UpPTS (Uplink Pilot TimeSlot). DwPTS is a period reserved for downlink transmission and UpPTS is a period reserved for uplink transmission. Table 2 shows special subframe configuration.

TABLE 2

| | Normal cyclic prefix in downlink | | | Extended cyclic prefix in downlink | | |
|---|---|---|---|---|---|---|
| | | UpPTS | | | UpPTS | |
| Special | | | Extended | | Normal | Extended |
| subframe | | Normal cyclic | cyclic prefix | | cyclic prefix | cyclic prefix |
| configuration | DwPTS | prefix in uplink | in uplink | DwPTS | in uplink | in uplink |
| 0 | 6592 · Tₛ | 2192 · Tₛ | 2560 · Tₛ | 7680 · Tₛ | 2192 · Tₛ | 2560 · Tₛ |
| 1 | 19760 · Tₛ | | | 20480 · Tₛ | | |
| 2 | 21952 · Tₛ | | | 23040 · Tₛ | | |
| 3 | 24144 · Tₛ | | | 25600 · Tₛ | | |
| 4 | 26336 · Tₛ | | | 7680 · Tₛ | 4384 · Tₛ | 5120 · Tₛ |
| 5 | 6592 · Tₛ | 4384 · Tₛ | 5120 · Tₛ | 20480 · Tₛ | | |
| 6 | 19760 · Tₛ | | | 23040 · Tₛ | | |
| 7 | 21952 · Tₛ | | | 12800 · Tₛ | | |
| 8 | 24144 · Tₛ | | | — | — | — |
| 9 | 13168 · Tₛ | | | — | — | — |

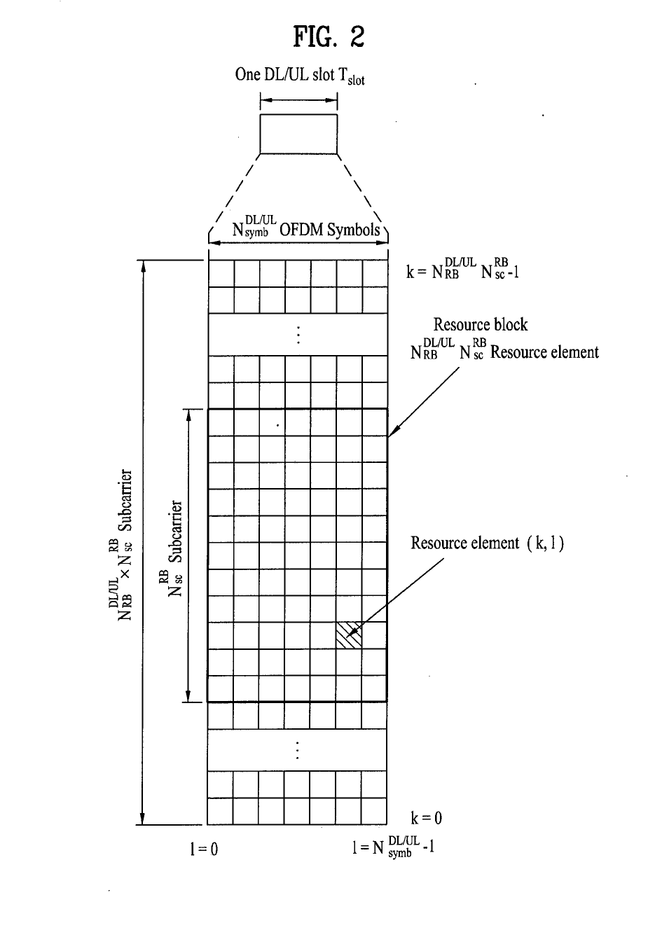

FIG. 2 illustrates an exemplary downlink/uplink slot structure in a wireless communication system. Particularly, FIG. 2 illustrates a resource grid structure in 3GPP LTE/LTE-A. A resource grid is present per antenna port.

Referring to FIG. 2, a slot includes a plurality of OFDM (Orthogonal Frequency Division Multiplexing) symbols in the time domain and a plurality of resource blocks (RBs) in the frequency domain. An OFDM symbol may refer to a symbol period. A signal transmitted in each slot may be represented by a resource grid composed of N_{RB}^{DL/UL}*N_{sc}^{RB} subcarriers and N_{symb}^{DL/UL} OFDM symbols. Here, N_{RB}^{DL} denotes the number of RBs in a downlink slot and N_{RB}^{UL} denotes the number of RBs in an uplink slot. N_{RB}^{DL} and N_{RB}^{UL} respectively depend on a DL transmission bandwidth and a UL transmission bandwidth. N_{symb}^{DL} denotes the number of OFDM symbols in the downlink slot and N_{symb}^{UL} denotes the number of OFDM symbols in the uplink slot. In addition, N_{sc}^{RB} denotes the number of subcarriers constructing one RB.

An OFDM symbol may be called an SC-FDM (Single Carrier Frequency Division Multiplexing) symbol according to multiple access scheme. The number of OFDM symbols included in a slot may depend on a channel bandwidth and the length of a cyclic prefix (CP). For example, a slot includes 7 OFDM symbols in the case of normal CP and 6 OFDM symbols in the case of extended CP. While FIG. 2 illustrates a subframe in which a slot includes 7 OFDM symbols for convenience, embodiments of the present invention can be equally applied to subframes having different numbers of OFDM symbols. Referring to FIG. 2, each OFDM symbol includes N_{RB}^{DL/UL}*N_{sc}^{RB} subcarriers in the frequency domain. Subcarrier types can be classified into a data subcarrier for data transmission, a reference signal subcarrier for reference signal transmission, and null subcarriers for a guard band and a direct current (DC) component. The null subcarrier for a DC component is a subcarrier remaining unused and is mapped to a carrier frequency (f0) during OFDM signal generation or frequency up-conversion. The carrier frequency is also called a center frequency.

An RB is defined by N_{symb}^{DL/UL} (e.g. 7) consecutive OFDM symbols in the time domain and N_{sc}^{RB} (e.g. 12) consecutive subcarriers in the frequency domain. For reference, a resource composed by an OFDM symbol and a subcarrier is called a resource element (RE) or a tone. Accordingly, an RB is composed of N_{symb}^{DL/UL}*N_{sc}^{RB} REs. Each RE in a resource grid can be uniquely defined by an index pair (k, l) in a slot. Here, k is an index in the range of 0 to N_{symb}^{DL/UL}*N_{sc}^{RB}−1 in the frequency domain and l is an index in the range of 0 to N_{symb}^{DL/UL}−1.

Two RBs that occupy N_{sc}^{RB} consecutive subcarriers in a subframe and respectively disposed in two slots of the subframe are called a physical resource block (PRB) pair. Two RBs constituting a PRB pair have the same PRB number (or PRB index). A virtual resource block (VRB) is a logical resource allocation unit for resource allocation. The VRB has the same size as that of the PRB. The VRB may be divided into a localized VRB and a distributed VRB depending on a mapping scheme of VRB into PRB. The localized VRBs are mapped into the PRBs, whereby VRB number (VRB index) corresponds to PRB number. That is, n_{PRB}=n_{VRB} is obtained. Numbers are given to the localized VRBs from 0 to N_{VRB}^{DL}−1, and N_{VRB}^{DL}=N_{RB}^{DL} is obtained. Accordingly, according to the localized mapping scheme, the VRBs having the same VRB number are mapped into the PRBs having the same PRB number at the first slot and the second slot. On the other hand, the distributed VRBs are mapped into the PRBs through interleaving. Accordingly, the VRBs having the same VRB number may be mapped into the PRBs having different PRB numbers at the first slot and the second slot. Two PRBs, which are respectively located at two slots of the subframe and have the same VRB number, will be referred to as a pair of VRBs.

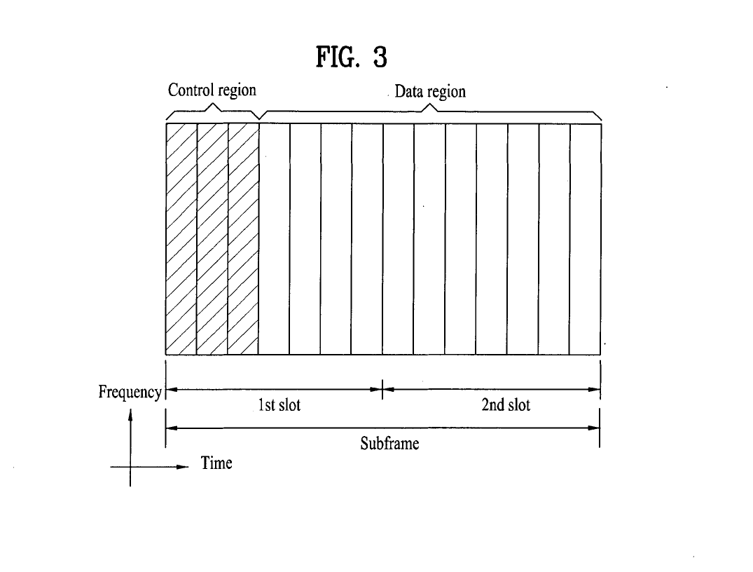

FIG. 3 illustrates a downlink (DL) subframe structure used in 3GPP LTE/LTE-A.

Referring to FIG. 3, a DL subframe is divided into a control region and a data region. A maximum of three (four) OFDM symbols located in a front portion of a first slot within a subframe correspond to the control region to which a control channel is allocated. A resource region available for PDCCH transmission in the DL subframe is referred to as a PDCCH region hereinafter. The remaining OFDM symbols correspond to the data region to which a physical downlink shared chancel (PDSCH) is allocated. A resource region available for PDSCH transmission in the DL subframe is referred to as a PDSCH region hereinafter. Examples of downlink control channels used in 3GPP LTE include a physical control format indicator channel (PCFICH), a physical downlink control channel (PDCCH), a physical hybrid ARQ indicator channel (PHICH), etc. The PCFICH is transmitted at a first OFDM symbol of a subframe and carries information regarding the number of OFDM symbols used for transmission of control channels within the subframe. The PHICH is a response of uplink transmission and carries an HARQ acknowledgment (ACK)/negative acknowledgment (NACK) signal.

Control information carried on the PDCCH is called downlink control information (DCI). The DCI contains resource allocation information and control information for a UE or a UE group. For example, the DCI includes a transport format and resource allocation information of a downlink shared channel (DL-SCH), a transport format and resource allocation information of an uplink shared channel (UL-SCH), paging information of a paging channel (PCH), system information on the DL-SCH, information about resource allocation of an upper layer control message such as a random access response transmitted on the PDSCH, a transmit control command set with respect to individual UEs in a UE group, a transmit power control command, information on activation of a voice over IP (VoIP), downlink assignment index (DAI), etc. The transport format and resource allocation information of the DL-SCH are also called DL scheduling information or a DL grant and the transport format and resource allocation information of the UL-SCH are also called UL scheduling information or a UL grant. The size and purpose of DCI carried on a PDCCH depend on DCI format and the size thereof may be varied according to coding rate. Various formats, for example, formats 0 and 4 for uplink and formats 1, 1A, 1B, 1C, 1D, 2, 2A, 2B, 2C, 3 and 3A for downlink, have been defined in 3GPP LTE. Control information such as a hopping flag, information on RB allocation, modulation coding scheme (MCS), redundancy version (RV), new data indicator (NDI), information on transmit power control (TPC), cyclic shift demodulation reference signal (DMRS), UL index, channel quality information (CQI) request, DL assignment index, HARQ process number, transmitted precoding matrix indicator (TPMI), precoding matrix indicator (PMI), etc. is selected and combined based on DCI format and transmitted to a UE as DCI.

In general, a DCI format for a UE depends on transmission mode (TM) set for the UE. In other words, only a DCI format corresponding to a specific TM can be used for a UE configured in the specific TM.

A PDCCH is transmitted on an aggregation of one or several consecutive control channel elements (CCEs). The CCE is a logical allocation unit used to provide the PDCCH with a coding rate based on a state of a radio channel. The CCE corresponds to a plurality of resource element groups (REGs). For example, a CCE corresponds to 9 REGs and an REG corresponds to 4 REs. 3GPP LTE defines a CCE set in which a PDCCH can be located for each UE. A CCE set from which a UE can detect a PDCCH thereof is called a PDCCH search space, simply, search space. An individual resource through which the PDCCH can be transmitted within the search space is called a PDCCH candidate. A set of PDCCH candidates to be monitored by the UE is defined as the search space. In 3GPP LTE/LTE-A, search spaces for DCI formats may have different sizes and include a dedicated search space and a common search space. The dedicated search space is a UE-specific search space and is configured for each UE. The common search space is configured for a plurality of UEs. Aggregation levels defining the search space is as follows.

TABLE 3

| | | | Number of |
|---|---|---|---|
| Search Space | | | PDCCH |
| Type | Aggregation Level L | Size [in CCEs] | candidates M^{(L)} |
| UE-specific | 1 | 6 | 6 |
| | 2 | 12 | 6 |
| | 4 | 8 | 2 |
| | 8 | 16 | 2 |
| Common | 4 | 16 | 4 |
| | 8 | 16 | 2 |

A PDCCH candidate corresponds to 1, 2, 4 or 8 CCEs according to CCE aggregation level. An eNB transmits a PDCCH (DCI) on an arbitrary PDCCH candidate with in a search space and a UE monitors the search space to detect the PDCCH (DCI). Here, monitoring refers to attempting to decode each PDCCH in the corresponding search space according to all monitored DCI formats. The UE can detect the PDCCH thereof by monitoring plural PDCCHs. Since the UE does not know the position in which the PDCCH thereof is transmitted, the UE attempts to decode all PDCCHs of the corresponding DCI format for each subframe until a PDCCH having the ID thereof is detected. This process is called blind detection (or blind decoding (BD)).

The eNB can transmit data for a UE or a UE group through the data region. Data transmitted through the data region may be called user data. For transmission of the user data, a physical downlink shared channel (PDSCH) may be allocated to the data region. A paging channel (PCH) and downlink-shared channel (DL-SCH) are transmitted through the PDSCH. The UE can read data transmitted through the PDSCH by decoding control information transmitted through a PDCCH. Information representing a UE or a UE group to which data on the PDSCH is transmitted, how the UE or UE group receives and decodes the PDSCH data, etc. is included in the PDCCH and transmitted. For example, if a specific PDCCH is CRC (cyclic redundancy check)-masked having radio network temporary identify (RNTI) of “A” and information about data transmitted using a radio resource (e.g. frequency position) of “B” and transmission format information (e.g. transport block size, modulation scheme, coding information, etc.) of “C” is transmitted through a specific DL subframe, the UE monitors PDCCHs using RNTI information and a UE having the RNTI of “A” detects a PDCCH and receives a PDSCH indicated by “B” and “C” using information about the PDCCH.

A reference signal (RS) to be compared with a data signal is necessary for the UE to demodulate a signal received from the eNB. A reference signal refers to a predetermined signal having a specific waveform, which is transmitted from the eNB to the UE or from the UE to the eNB and known to both the eNB and UE. The reference signal is also called a pilot. Reference signals are categorized into a cell-specific RS shared by all UEs in a cell and a modulation RS (DM RS) dedicated for a specific UE. A DM RS transmitted by the eNB for demodulation of downlink data for a specific UE is called a UE-specific RS. Both or one of DM RS and CRS may be transmitted on downlink. When only the DM RS is transmitted without CRS, an RS for channel measurement needs to be additionally provided because the DM RS transmitted using the same precoder as used for data can be used for demodulation only. For example, in 3GPP LTE(-A), CSI-RS corresponding to an additional RS for measurement is transmitted to the UE such that the UE can measure channel state information. CSI-RS is transmitted in each transmission period corresponding to a plurality of subframes based on the fact that channel state variation with time is not large, unlike CRS transmitted per subframe.

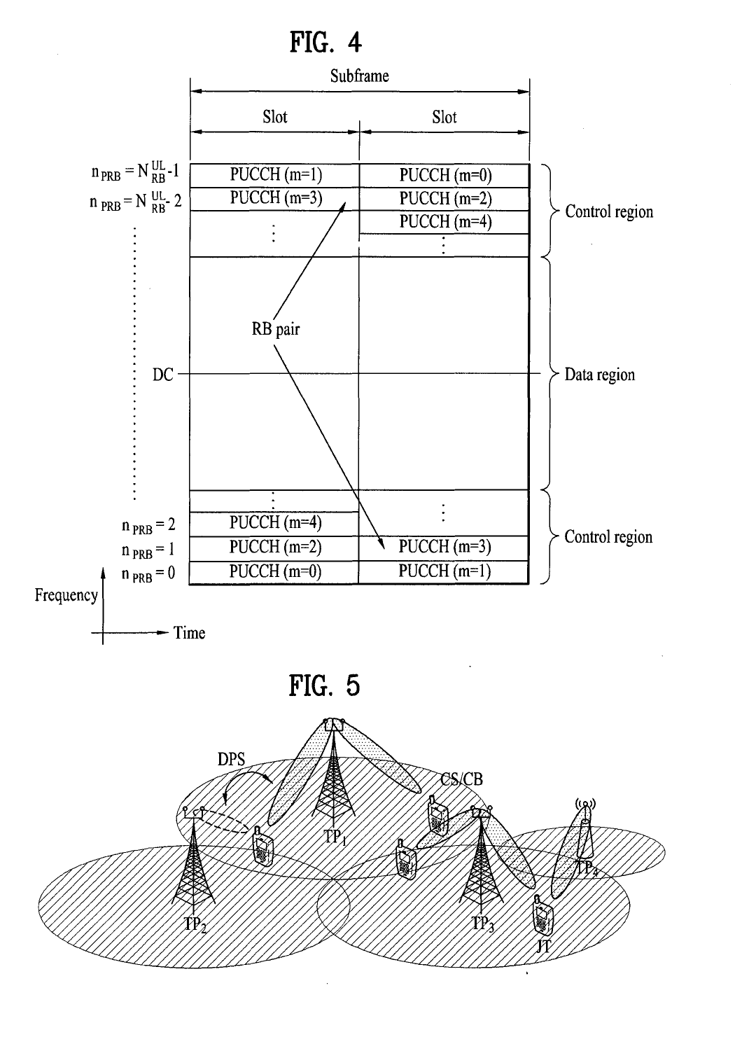

FIG. 4 illustrates an exemplary uplink subframe structure used in 3GPP LTE/LTE-A.

Referring to FIG. 4, a UL subframe can be divided into a control region and a data region in the frequency domain. One or more PUCCHs (physical uplink control channels) can be allocated to the control region to carry uplink control information (UCI). One or more PUSCHs (Physical uplink shared channels) may be allocated to the data region of the UL subframe to carry user data.

In the UL subframe, subcarriers spaced apart from a DC subcarrier are used as the control region. In other words, subcarriers corresponding to both ends of a UL transmission bandwidth are assigned to UCI transmission. The DC subcarrier is a component remaining unused for signal transmission and is mapped to the carrier frequency PO during frequency up-conversion. A PUCCH for a UE is allocated to an RB pair belonging to resources operating at a carrier frequency and RBs belonging to the RB pair occupy different subcarriers in two slots. Assignment of the PUCCH in this manner is represented as frequency hopping of an RB pair allocated to the PUCCH at a slot boundary. When frequency hopping is not applied, the RB pair occupies the same subcarrier.

The PUCCH can be used to transmit the following control information.
Scheduling Request (SR): This is information used to request a UL-SCH resource and is transmitted using On-Off Keying (OOK) scheme.
HARQ ACK/NACK: This is a response signal to a downlink data packet on a PDSCH and indicates whether the downlink data packet has been successfully received. A 1-bit ACK/NACK signal is transmitted as a response to a single downlink codeword and a 2-bit ACK/NACK signal is transmitted as a response to two downlink codewords. HARQ-ACK responses include positive ACK (ACK), negative ACK (NACK), discontinuous transmission (DTX) and NACK/DTX. Here, the term HARQ-ACK is used interchangeably with the term HARQ ACK/NACK and ACK/NACK.
Channel State Indicator (CSI): This is feedback information about a downlink channel. Feedback information regarding MIMO includes a rank indicator (RI) and a precoding matrix indicator (PMI).

The quantity of control information (UCI) that a UE can transmit through a subframe depends on the number of SC-FDMA symbols available for control information transmission. The SC-FDMA symbols available for control information transmission correspond to SC-FDMA symbols other than SC-FDMA symbols of the subframe, which are used for reference signal transmission. In the case of a subframe in which a sounding reference signal (SRS) is configured, the last SC-FDMA symbol of the subframe is excluded from the SC-FDMA symbols available for control information transmission. A reference signal is used to detect coherence of the PUCCH. The PUCCH supports various formats according to information transmitted thereon.

Table 4 shows the mapping relationship between PUCCH formats and UCI in LTE/LTE-A.

TABLE 4

| | | Number of | | |
|---|---|---|---|---|
| | Modu- | bits per | | |
| PUCCH | lation | subframe, | | |
| format | scheme | M_{bit} | Usage | Etc. |
| 1 | N/A | N/A | SR (Scheduling | |
| | | | Request) | |
| 1a | BPSK | 1 | ACK/NACK or | One codeword |
| | | | SR + ACK/NACK | |
| 1b | QPSK | 2 | ACK/NACK or | Two codeword |
| | | | SR + ACK/NACK | |
| 2 | QPSK | 20 | CQI/PMI/RI | Joint coding |
| | | | | ACK/NACK |
| | | | | (extended |
| | | | | CP) |
| 2a | QPSK + | 21 | CQI/PMI/RI + | Normal CP |
| | BPSK | | ACK/NACK | only |
| 2b | QPSK + | 22 | CQI/PMI/RI + | Normal CP |
| | QPSK | | ACK/NACK | only |
| 3 | QPSK | 48 | ACK/NACK or | |
| | | | SR + ACK/NACK or | |
| | | | CQI/PMI/RI + | |
| | | | ACK/NACK | |

Referring to Table 4, PUCCH formats 1/1a/1b are used to transmit ACK/NACK information, PUCCH format 2/2a/2b are used to carry CSI such as CQI/PMI/RI and PUCCH format 3 is used to transmit ACK/NACK information.

Reference Signal (RS)

When a packet is transmitted in a wireless communication system, signal distortion may occur during transmission since the packet is transmitted through a radio channel. To correctly receive a distorted signal at a receiver, the distorted signal needs to be corrected using channel information. To detect channel information, a signal known to both a transmitter and the receiver is transmitted and channel information is detected with a degree of distortion of the signal when the signal is received through a channel. This signal is called a pilot signal or a reference signal.

When data is transmitted/received using multiple antennas, the receiver can receive a correct signal only when the receiver is aware of a channel state between each transmit antenna and each receive antenna. Accordingly, a reference signal needs to be provided per transmit antenna, more specifically, per antenna port.

Reference signals can be classified into an uplink reference signal and a downlink reference signal. In LTE, the uplink reference signal includes:

i) a demodulation reference signal (DMRS) for channel estimation for coherent demodulation of information transmitted through a PUSCH and a PUCCH;

and

ii) a sounding reference signal (SRS) used for an eNB to measure uplink channel quality at a frequency of a different network.

The downlink reference signal includes:

i) a cell-specific reference signal (CRS) shared by all UEs in a cell;

ii) a UE-specific reference signal for a specific UE only;

iii) a DMRS transmitted for coherent demodulation when a PDSCH is transmitted;

iv) a channel state information reference signal (CSI-RS) for delivering channel state information (CSI) when a downlink DMRS is transmitted;

v) a multimedia broadcast single frequency network (MBSFN) reference signal transmitted for coherent demodulation of a signal transmitted in MBSFN mode; and

vi) a positioning reference signal used to estimate geographic position information of a UE.

Reference signals can be classified into a reference signal for channel information acquisition and a reference signal for data demodulation. The former needs to be transmitted in a wide band as it is used for a UE to acquire channel information on downlink transmission and received by a UE even if the UE does not receive downlink data in a specific subframe. This reference signal is used even in a handover situation. The latter is transmitted along with a corresponding resource by an eNB when the eNB transmits a downlink signal and is used for a UE to demodulate data through channel measurement. This reference signal needs to be transmitted in a region in which data is transmitted.

CoMP (Coordinated Multiple Point Transmission and Reception)

FIG. 5 is a conceptual diagram illustrating a network structure for use in a CoMP (Coordinated Multiple Point) transmission and reception scheme according to one embodiment of the present invention. FIG. 5 is a conceptual diagram illustrating a heterogeneous network (HetNet) environment in which the CoMP UE connected to different DL/UL serving cells is connected to the serving cells. Although FIG. 5 shows four eNBs (TP1, TP2, TP3, TP4) and four UEs, the scope or spirit of the present invention is not limited thereto and many more eNBs and many more UEs can also be present in the above network structure.

In accordance with the improved system throughput requirements of the 3GPP LTE-A system, CoMP transmission/reception technology (also referred to as Co-MIMO, collaborative MIMO or network MIMO) has recently been proposed. The CoMP technology can increase throughput of a UE located at a cell edge and also increase average sector throughput.

In general, in a multi-cell environment in which a frequency reuse factor is 1, the performance of the UE located on the cell edge and average sector throughput may be reduced due to Inter-Cell Interference (ICI). In order to reduce the ICI, in the legacy LTE system, a method of enabling the UE located at the cell edge to have appropriate throughput and performance using a simple passive method such as Fractional Frequency Reuse (FFR) through the UE-specific power control in the environment restricted by interference is applied. However, rather than decreasing the use of frequency resources per cell, it is preferable that the ICI is reduced or the UE reuses the ICI as a desired signal. In order to accomplish the above object, a CoMP transmission scheme may be applied.

The CoMP scheme applicable to the downlink may be largely classified into a Joint Processing (JP) scheme and a Coordinated Scheduling/Beamforming (CS/CB) scheme.

In the JP scheme, each point (eNB) of a CoMP unit may use data. The CoMP unit refers to a set of eNBs used in the CoMP scheme. The JP scheme may be classified into a joint transmission scheme and a dynamic cell selection scheme.

The joint transmission scheme refers to a scheme for transmitting a PDSCH from a plurality of points (a part or the whole of the CoMP unit). That is, data transmitted to a single UE may be simultaneously transmitted from a plurality of transmission points. According to the joint transmission scheme, it is possible to coherently or non-coherently improve the quality of the received signals and to actively eliminate interference with another UE.

The dynamic cell selection scheme refers to a scheme for transmitting a PDSCH from one point (of the CoMP unit). That is, data transmitted to a single UE at a specific time is transmitted from one point and the other points in the cooperative unit at that time do not transmit data to the UE. The point for transmitting the data to the UE may be dynamically selected.

According to the CS/CB scheme, the CoMP units may cooperatively perform beamforming of data transmission to a single UE. Although only a serving cell transmits the data, user scheduling/beamforming may be determined by coordination of the cells of the CoMP unit.

In uplink, coordinated multi-point reception refers to reception of a signal transmitted by coordination of a plurality of geographically separated points. The CoMP scheme applicable to the uplink may be classified into Joint Reception (JR) and Coordinated Scheduling/Beamforming (CS/CB).

The JR scheme indicates that a plurality of reception points receives a signal transmitted through a PUSCH, the CS/CB scheme indicates that only one point receives a PUSCH, and user scheduling/beamforming is determined by the coordination of the cells of the CoMP unit.

In addition, one case in which there are multiple UL points (i.e., multiple Rx points) is referred to as UL CoMP, and the other case in which there are multiple DL points (i.e., multiple Tx points) is referred to as DL CoMP.

The present invention proposes a signaling method for providing autonomy to each evolved node B (eNB) for scheduling and data transmission schemes by a center eNB capable of acquiring information from a plurality of eNBs participating in coordinated multiple point transmission and reception (CoMP) and capable of exchanging information through non-ideal backhaul (NIB) having a backhaul delay in a DL wireless communication system.

Ideal backhaul (IB) through which eNBs participating in CoMP can exchange information with no time delay was assumed for the LTE Rel-11 system. Accordingly, a specific single controller exists to acquire information for scheduling and information for data transmission individually from eNBs with no time delay, and thus to instantaneously determine data scheduling and data transmission schemes of eNBs participating in CoMP. However, IB can be supported only in the form of fiber access in real implementation and is defined for the LTE system as shown below.

TABLE 5

| Backhaul | | | Priority (1 is the |
|---|---|---|---|
| Technology | Latency (One way) | Throughput | highest) |
| Fiber Access 4 | less than 2.5 us | Up to 10 Gbps | 1 |

Accordingly, for the LTE Rel-12 system, a scheme for ensuring the advantages of CoMP even when NIB is applied is under discussion in consideration of a more practical environment. The first thing to be considered when CoMP is applied to the NIB environment is that a time delay can exist in information exchange among eNBs. For example, NIB can be classified for the LTE system as shown below.

TABLE 6

| Backhaul | Latency | | Priority (1 is the |
|---|---|---|---|
| Technology | (One way) | Throughput | highest) |
| Fiber Access 1 | 10-30 ms | 10 M-10 Gbps | 1 |
| Fiber Access 2 | 5-10 ms | 100-1000 Mbps | 2 |
| Fiber Access 3 | 2-5 ms | 50 M-10 Gbps | 1 |
| DSL Access | 15-60 ms | 10-100 Mbps | 1 |
| Cable | 25-35 ms | 10-100 Mbps | 2 |
| Wireless | 5-35 ms | 10 Mbps-100 Mbps | 1 |
| Backhaul | | typical, maybe up to | |
| | | Gbps range | |

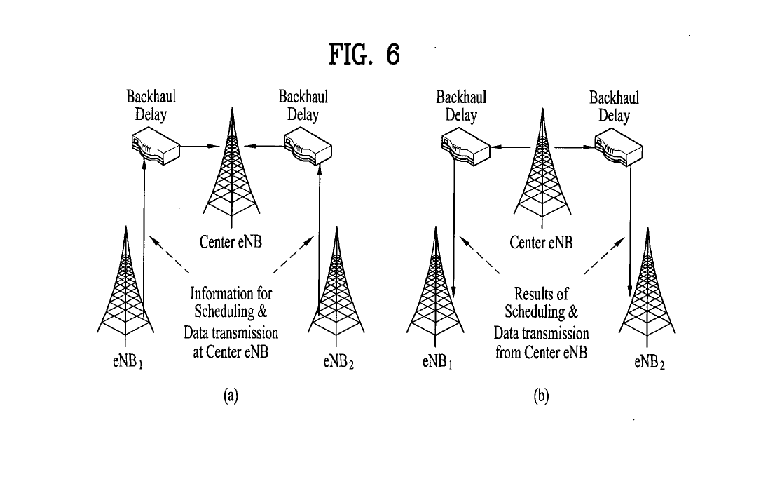

UEs served by eNBs participating in CoMP can be selected in a combination for maximizing a scheduling metric among all UEs and scheduled instantaneously by a single controller in the LTE Rel-11 system. However, in the Rel-12 system, when a single controller acquires information individually from eNBs to determine scheduling and data transmission schemes, the information is delayed due to a backhaul delay of NIB. In addition, even when the single controller detects scheduling and data transmission schemes based on previous information, a time delay also occurs until each eNB actually applies the same. FIG. 6 illustrates this time delay. Specifically, FIG. 6(a) illustrates a time delay when a center eNB having a single controller for determining scheduling and data transmission schemes of eNBs participating in CoMP receives information for scheduling and information for data transmission from eNBs, and FIG. 6(b) illustrates a time delay when the center eNB transmits the determined data scheduling and data transmission schemes to each eNB.

That is, in an NIB environment, the single controller cannot instantaneously support optimized scheduling and data transmission schemes and the scheduling and data transmission schemes transmitted to each eNB can be delayed by a delay time of NIB. In this case, if each eNB follows the delayed scheduling and data transmission schemes determined by the single controller, system performance can be reduced.

To solve the above problem, the present invention proposes a signaling method for providing autonomy to each eNB for scheduling by a center eNB capable of acquiring information from a plurality of eNBs participating in CoMP in the above NIB environment. In the present invention, signaling is largely categorized into 4 steps as described below. Although the LTE system is given as a specific example in the following description, operation of the present invention may be extensively applied to a general wireless communication system to which a scheduling scheme is applicable.

I. Signaling for CoMP—when Center eNB Exists

1.1. Step 1—Determination of Resource Unit

Initially, the center eNB receives a resource unit of CSI report from each eNB through NIB. After that, the center eNB calculates a minimum resource unit of CSI report with reference to resource units of CSI report of all UEs and then transmits information about the corresponding resource unit to each eNB through NIB.

1.2. Step 2—Acquisition of Information of eNBs Participating in CoMP by Center eNB

1.2.1 Acquisition of Information of eNBs Participating in CoMP by Center eNB: Data Transmission Information, Etc.

Each eNB may report information for data transmission, e.g., CRS transmission power, RNTI of UE, HARQ process status of UE, data to be transmitted to UE, transmission mode (TM) of UE, CSI for each resource unit and codebook type, and an average yield of each UE necessary to obtain a scheduling metric, to the center eNB. In this case, when the information about the CSI and the scheduling metric is reported, each eNB may report information about a plurality of CSI and scheduling metrics corresponding to a plurality of CSI processes of each UE to the center eNB.

1.2.2. Acquisition of Information of eNBs Participating in CoMP by Center eNB: Data Queue and Receiver Buffer Status

The present invention proposes a scheme for transmitting transmission queue status information (e.g., queue length) of a UE to the center eNB through backhaul signaling by each of the eNBs participating in CoMP. In a wireless communication system such as LTE, packets can be accumulated in a transmission queue to be transmitted for a specific UE as a user uses applications. In this case, if the number of packets accumulated in the transmission queue increases, the corresponding UE experiences a delay of packet transmission and this can cause performance degradation in view of throughput. Accordingly, a packet scheduling scheme such as maximum delay scheduling for giving a high weight to a scheduling metric of a UE having a large number of packets accumulated in the transmission queue is under consideration. To support scheduling of the above scheme, each eNB may transmit transmission queue information of a specific UE or transmission queue information of every UE to the center eNB through NIB.
Transmission queue status: The status of a transmission queue of a specific UE can be used to minimize a packet transmission delay (For example, a high scheduling metric can be indicated if the transmission queue is long).

The present invention also proposes a scheme for transmitting status information of a receiver buffer to the center eNB through backhaul signaling by each of the eNBs participating in CoMP to prevent a problem such as overflow of the receiver buffer. In this case, the status information of the receiver buffer may include information such as an available buffer size.

Buffer status: The status of a receiver buffer can be used to avoid buffer overflow (For example, a high scheduling metric can be indicated if the receiver buffer has a large available space).

1.2.3. Acquisition of Information of eNBs Participating in CoMP by Center eNB: QoS (Quality of Service)

1.2.3.1. QCI for QoS Requirements

Each of the eNBs participating in CoMP may transmit an indicator of QoS of UE to the center eNB through backhaul signaling. In the 3GPP LTE system, data for an application executed by a UE is provided by establishing packet data network (PDN) connection or creating an evolved packet system (EPS) session between the UE and a PDN. When the EPS session is created, an EPS bearer is established between the UE and a PDN gate way (P-GW). 2 resource types of the EPS bearer are considered in the LTE system. First is a guaranteed bit rate (GBR) bearer which is an EPS bearer capable of ensuring a given bandwidth. In this case, a GBR parameter and a maximum bit rate (MBR) exist to restrict minimum and maximum bandwidths of the GBR bearer. Unlike the GBR bearer, a non-GBR bearer is a best effort type EPS bearer incapable of ensuring a given bandwidth. The GBR bearer or the non-GBR bearer of the LTE system receives allocation of a QoS class identifier (QCI) indicating the level of QoS. The QCI is defined as shown in Table 7.

TABLE 7

| | Resource | | Packet Delay | Packet Loss | |
|---|---|---|---|---|---|
| QCT | Type | Priority | Budget [ms] | Rate | Example services |
| 1 | GBR | 2 | 100 | 10⁻² | Conversational voice |
| 2 | GBR | 4 | 150 | 10⁻³ | Conversational video (live streaming) |
| 3 | GBR | 5 | 300 | 10⁻⁶ | Non-Conversational video (buffered streaming) |
| 4 | GBR | 3 | 50 | 10⁻³ | Real time gaming |
| 5 | non-GBR | 1 | 100 | 10⁻⁶ | IMS signaling |
| 6 | non-GBR | 7 | 100 | 10⁻³ | Voice, video (live streaming), interactive gaming |
| 7 | non-GBR | 6 | 300 | 10⁻⁶ | Video (buffered streaming) |
| 8 | non-GBR | 8 | 300 | 10⁻⁶ | TCP based (e.g., WWW, e-mail), chat, FTP, |
| 9 | non-GBR | 9 | 300 | 10⁻⁶ | P2P file sharing |

In this case, the QCI can be a target to be considered to determine a scheduling metric when a CoMP operation is performed. For example, a weight can be given to the scheduling metric according to the priority indicated by the QCI. As such, the present invention proposes a scheme for reporting QCI of UE to the center eNB through backhaul signaling by each of the eNBs participating in CoMP. Table 8 shows an example of backhaul signaling.

Information about QoS requirements: A QCI value related to each flow can be used to derive specific policies to satisfy QoS requirements.

TABLE 8

| IE/ | | | IE type and | Semantics |
|---|---|---|---|---|
| Group Name | Presence | Range | reference | description |
| QCI | M | | INTEGER (1 . . . 9) | An example of |
| (QoS Class | | | | each QCI value |
| Identifier) | | | | is as shown in |
| | | | | <Table X>. |

1.2.3.2. Other Parameters for QoS Requirements

The present invention proposes a scheme for individually transmitting QoS requirements for a packet delay of UE and an acceptable packet loss rate to the center eNB through backhaul signaling by each of the eNBs participating in CoMP. The QoS requirements of the UE can be required to instruct each eNB to perform a CoMP operation by the center eNB. That is, the center eNB may calculate a scheduling metric using UE QoS requirements of each eNB and request a specific eNB to perform muting or low-power transmission in a specific resource region. In this case, the QoS requirements can be indicated by QCI and only a part of the information can be requested as necessary. For example, when packets for an application such as voice over Internet protocol (VoIP) are transmitted in the 3GPP LTE system, if only packet delay requirements are transmitted to the center eNB or if packets for an application such as file transfer protocol (FTP) are transmitted, requirements for an acceptable packet loss rate can be transmitted to the center eNB.

Tᵢ: A delay threshold for an i^{th} user

D_{HOL,i}: A head of line delay (e.g., a delay of a first packet to be transmitted by the i^{th} user)

For example, the scheduling metric is determined as 1/(Tᵢ−D_{HOL,i}) and increased if the head of line delay is close to the threshold.

dᵢ: An acceptable packet loss rate for the i^{th} user

The scheduling metric is determined as −log(dᵢ)/Tᵢ·D_{HOL,i}. For example, if two given flows have the same head of line delay, the parameter −log(dᵢ)/Tᵢ applies a weight to the scheduling metric and a UE having strict requirements in relation to an acceptable loss rate and deadline expiration will be preferred.

1.2.3.3. UE Status for QoS

The present invention proposes a scheme for reporting a head of line delay, an acceptable packet loss rate, etc. as QoS information of UE to the center eNB through backhaul signaling by each of the eNBs participating in CoMP. Even when the eNBs participating in CoMP transmit only QCI of UE to the center eNB as described in 1.2.3.1, the center eNB may acquire requirements for priority of packets to be transmitted to the UE, a packet delay, an acceptable packet loss rate, etc. using the QCI. However, if QoS requirements according to the QCI only are used for scheduling, a current QoS status of the UE cannot be easily reflected. That is, backhaul signaling for weighting a scheduling metric when a delay approaches a limitation thereof relative to QoS requirements or if a packet loss rate approaches a limitation thereof may be necessary. Accordingly, the present invention proposes a scheme for reporting a head of line delay, an acceptable packet loss rate, etc. as QoS information of UE to the center eNB through backhaul signaling by each of the eNBs participating in CoMP.

1.2.3.4. Allocated Resource Blocks for GBR

A description is now given of a scheme for transmitting information about a frequency resource region allocated for GBR bearers to the center eNB through backhaul signaling by each of the eNBs participating in CoMP. Each eNB can operate dedicated EPS bearers based on operation of an application such as VoIP. In this case, if the EPS bearers are used as GBR bearers, a fixed resource region which is changeable only for bearer establishment and bearer modification is allocated. At this time, data sensitive to QoS can be transmitted in the resource region, e.g., data transmission for VoIP application. Accordingly, the eNB may transmit information about a resource region allocated thereby for GBR bearers, to the center eNB and may not participate in a CoMP operation in the resource region. In this case, the center eNB and the eNBs participating in CoMP may previously have an agreement to perform no CoMP operation in the GBR bearer resources.

If information for VoIP application is relatively smaller than FTP application information, resource regions allocated for GBR bearers to transmit VoIP data among eNBs performing a CoMP operation may be configured to be the same and thus VoIP communication may be performed in a low-interference environment. On contrary, the resource regions allocated for the GBR bearers may be configured not to overlap each other among the eNBs and thus the level of interference for FTP data transmission may be reduced using a low amount of traffic of resources for VoIP data transmission. Accordingly, to allow the center eNB to adjust resource regions allocated for GBR bearers among the eNBs participating in CoMP, each eNB may transmit bandwidth information of GBR bearers thereof (e.g., GBR, MBR) to the center eNB through backhaul signaling, and the center eNB may report resource allocation information of each GBR bearer of each eNB to report a CoMP determination to the corresponding eNB.

Adjusting transmission positions of data for GBR bearers and data for non-GBR bearers in view of performing CoMP as described above may be preferable in view of adjusting interference characteristics. For example, in an environment in which data transmission requests for VoIP application are relatively less than data transmission for FTP application, resource regions for VoIP application data transmission may be configured to be the same within cells participating in CoMP to reduce interference for the VoIP application data, or resource regions for VoIP application data transmission and resource regions for FTP application data transmission may be mixed to reduce overall interference. Accordingly, the center eNB may report a start point of resource allocation for data corresponding to GBR bearers of each eNB. That is, the center eNB may adjust resource regions of data corresponding to GBR bearers by configuring points of time for transmitting the data corresponding to the GBR bearers by the eNBs, to be the same or not to overlap each other.

1.2.4. Acquisition of Information of eNBs Participating in CoMP by Center eNB: UE Scheduling Metric or Utility

Backhaul signaling described above in 1.2.1, 1.2.2 and 1.2.3 is appropriate when the center eNB acquires a large amount of information about UEs belonging to each eNB and calculates scheduling metrics. However, since a scheduler actually used in a scheduling procedure is variable depending on implementation of a network operator, if the center eNB performs scheduling by hypothesizing a CoMP operation, each eNB should transmit information about all UEs, which can be required by an arbitrary scheduler, to the center eNB through backhaul signaling to support all scheduler types. This scheme causes excessive backhaul signaling compared to the utility of CoMP NIB and thus can make the system inefficient.

Accordingly, the present invention defines a set of candidates of CoMP operations (hereinafter referred to as “CoMP candidate set”) and proposes a scheme for calculating a scheduling metric or utility of UEs for each CoMP candidate according to hypotheses of the CoMP candidate set for every certain resource unit (e.g., subband or resource block) and reporting the calculated scheduling metric or utility to the center eNB through backhaul signaling by the eNBs. That is, the scheduling metric or utility calculated in the CoMP candidate set which hypothesizes operations of the eNBs participating in CoMP operations can be transmitted to the center eNB. For example, when a total of three eNBs, e.g., eNB₁, eNB₂ and eNB₃ can participate in the CoMP candidate set, the CoMP candidate set may include CoMP candidate 1 corresponding to muting of eNB₂, CoMP candidate 2 corresponding to muting of eNB₃ and CoMP candidate 3 corresponding to muting of eNB₂ and muting of eNB₃. Meanwhile, information about a certain resource unit can also be included in the hypothesis as described above. In this case, the hypothesis of the CoMP candidate set, i.e., CoMP hypothesis, may be defined as resource allocation information for a specific CoMP operation for each certain resource unit.

For example, the scheduling metric can be fed back as a result value of a specific function (e.g., quantization) as shown below.

TABLE 9

| IE/ | | | IE type and | Semantics |
|---|---|---|---|---|
| Group Name | Presence | Range | reference | description |
| UE scheduling | M | | BIT STRING(SIZE | |
| metric | | | (N)) | |
| (for CoMP) | | | | |

Table 9 corresponds to a case in which the scheduling metric is defined as a bit string of size N (e.g., N=1024). At this time, the N bit-bit size can be defined as N=N_subband*M_metric. In this case, N_subband denotes a total number of subbands and an actual frequency unit (e.g., PRB or PRG) of each subband can be defined previously or changed through additional signaling. For example, when N_subband=8 and M_metric=128, a value of a specific scheduling metric expressed as M_metric=128 bits can be mapped to each subband.

Further, each M_metric bit can be configured as M_metric=N_candidate*M_metric2. For example, when N_candidate=8 and M_metric2=16, a total of 8 different CoMP candidates are considered and a result value of calculating a scheduling metric quantized by M_metric2=16 bits is mapped to each candidate and is transmitted to the center eNB.

In this case, a status of the bit field indicating the scheduling metric or utility (e.g., M_metric2) can be used as an indicator of an eNB which rejects a CoMP operation in a corresponding resource unit and a corresponding CoMP candidate.

In addition, a value indicated by the bit field indicating the scheduling metric or utility (e.g., M_metric2) can represent an integrated UE scheduling metric or utility achievable in a corresponding resource unit when 2 or more UEs are simultaneously supported due to, for example, MU-MIMO.

A description is given of the above-described CoMP candidate set as an example. eNB₁ may calculate a scheduling metric or utility of a UE served thereby by hypothesizing muting of eNB₂ according to CoMP candidate 1, calculate a scheduling metric or utility of the UE served thereby by hypothesizing muting of eNB₃ according to CoMP candidate 2, and calculate a scheduling metric or utility of the UE served thereby by hypothesizing muting of eNB₂ and eNB₃ according to CoMP candidate 3. eNB₁ may transmit the calculated scheduling metrics or utilities to the center eNB together with the associated corresponding CoMP candidates (or hypotheses).

1.2.5. Acquisition of Information of eNBs Participating in CoMP by Center eNB: CoMP Candidate Set

1.2.5.1. Acquisition of Information of eNBs Participating in CoMP by Center eNB: PM (Point Muting)

As a scheme for providing CoMP candidate set information by the eNBs participating in CoMP, the eNBs may transmit cell-ID information for each CoMP candidate and N-bit information about the level of transmission power to the center eNB through backhaul signaling. When the CoMP candidate set information is defined by the eNBs, a CoMP candidate set for a PM operation can be defined as eNBs hypothesized to perform muting. For example, if eNB₁, eNB₂ and eNB₃ exist and eNB₁ is a serving eNB, the CoMP candidate set can be defined as described below.

CoMP candidate 1: cell-ID of eNB₂

CoMP candidate 2: cell-ID of eNB₃

CoMP candidate 3: cell-ID of eNB₂, cell-ID of eNB₃

That is, an eNB, cell-ID information of which is transmitted, can be defined to perform muting. Further, when the intensity of transmission power is adjusted without additionally performing muting, N-bit information may be added to the cell-ID information as described below to represent which of 2^{N} levels of transmission power of a corresponding eNB is hypothesized. Alternatively, it can be defined that an eNB indicated by cell-ID information may transmit signal using predetermined transmission power without addition of the N-bit information.

CoMP candidate 1: (cell-ID of eNB₂+N bits)

CoMP candidate 2: (cell-ID of eNB₃+N bits)

CoMP candidate 3: (cell-ID of eNB₂+N bits), (cell-ID of eNB₃+N bits)

1.2.5.2. Acquisition of Information of eNBs Participating in CoMP by Center eNB: CB (Coordinated Beamforming)

The eNBs participating in CoMP may transmit cell-ID information for each CoMP candidate and N-bit information about precoding to the center eNB through backhaul signaling to provide CoMP candidate set information. When the CoMP candidate set information is defined by the eNBs, a CoMP candidate set for a CB operation can be defined as eNBs hypothesized to perform precoding and types of precoding. For example, if eNB₁, eNB₂ and eNB₃ exist and eNB₁ is a serving eNB, when N bits are used for precoding information, the CoMP candidate set can be defined as described below.

CoMP candidate 1: (cell-ID of eNB₂+N bits)

CoMP candidate 2: (cell-ID of eNB₃+N bits)

CoMP candidate 3: (cell-ID of eNB₂+N bits), (cell-ID of eNB₃+N bits)

That is, an eNB, cell-ID information of which is transmitted, can be defined to use precoding indicated by the N bits.

In this case, the center eNB may determine and report the CoMP candidate set to the eNBs participating in CoMP through backhaul signaling.

1.2.6. Unit for Acquiring Information of eNBs Participating in CoMP by Center eNB

1.2.6.1. Information about a Plurality of CoMP Candidates for all UEs is Acquired and Transmitted for Every Resource Unit

Each of the eNBs participating in CoMP may acquire and transmit the information described above in 1.2.1, 1.2.2, 1.2.3 and 1.2.4 for CoMP candidates and/or all UEs to the center eNB through backhaul signaling for every predefined certain resource unit. That is, each eNB may transmit information about all UEs belonging thereto to the center eNB and the center eNB may report CoMP determination thereof to the eNB based on the information.

1.2.6.2. Information about a Plurality of CoMP Candidates for Specific UE is Acquired and Transmitted, or Single Metric is Transmitted for Every Resource Unit

Each of the eNBs participating in CoMP may acquire and transmit information about a plurality of CoMP candidates for specific UEs, or a single metric to the center eNB through backhaul signaling for every predefined certain resource unit. For example, the eNB may provide a value of a single scheduling metric (or utility) selected according to scheduling criteria thereof for each CoMP hypothesis for each certain resource unit as shown in Table 9.

1.3. Step 3—Definition of Data Transmission Information

The center eNB may configure data transmission information based on the information and received from each of the eNBs participating in CoMP and described above in 1.2. The center eNB may report the data transmission information to each eNB through NIB, and the present invention proposes a method for reporting the data transmission information for each UE and a method for reporting the data transmission information for each resource unit.

Referring to 1.2.4, the center eNB could have been already received scheduling metrics and associated CoMP hypotheses from each eNB. The center eNB may determine a CoMP hypothesis indicating a CoMP operation to be scheduled, based on the received scheduling metrics and the associated CoMP hypotheses. For example, the center eNB may determine to actually schedule a CoMP operation indicated by a CoMP hypothesis corresponding to a scheduling metric having the highest value. Meanwhile, if the center eNB is not designated separately in the CoMP operation, each eNB may receive scheduling metrics and associated CoMP hypotheses from neighbor eNBs, conduct negotiations for a CoMP operation to be actually scheduled, and determine a CoMP hypothesis indicating the CoMP operation to be scheduled.

1.3.1. Configuration of Data Transmission Information for Each UE

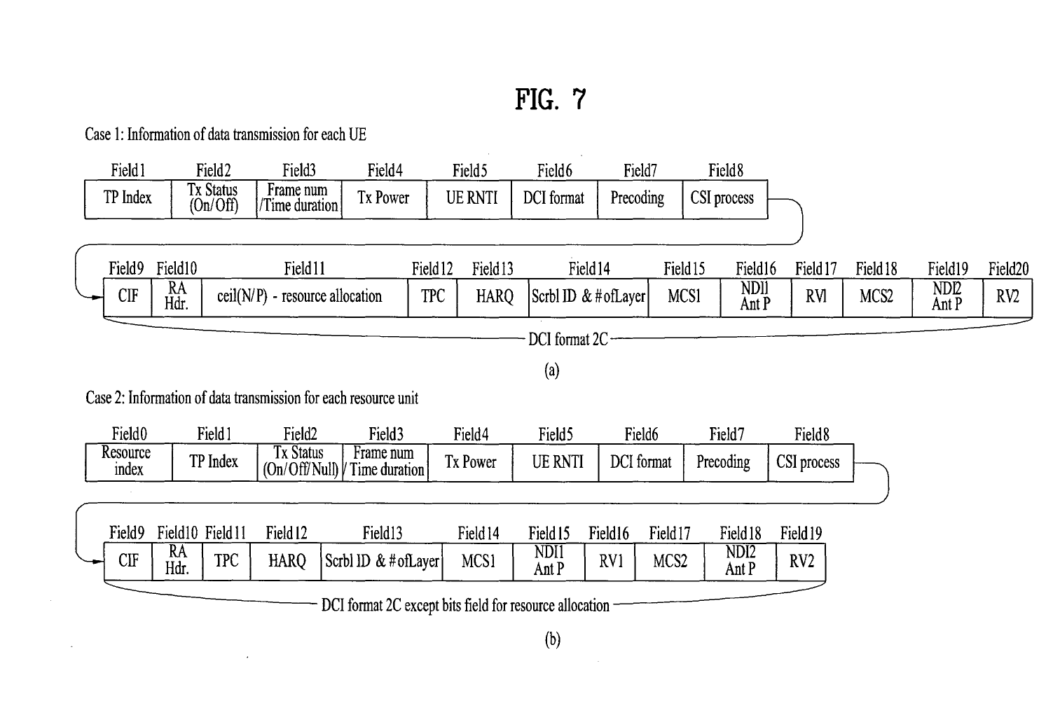

FIG. 7 illustrates an example of data information configuration for each UE. Fields from field 9 assume DCI format 2C.

FIG. 7(a) illustrates fields of data transmittable to each UE. The center eNB may configure the following information for each UE for performing data transmission or data muting. Field 1 indicates a transmission point at which data transmission or data muting is actually performed. Field 2 indicates a data transmission status as one of {On, Off}. Here, On means that there is data transmission instructed by the center eNB, and Off means that there is data muting instructed by the center eNB. In this case, additional data transmission information is not reported through NIB to a UE having no instruction from the center eNB. This means that autonomy is given to each eNB for data transmission of the corresponding UE. Field 3 indicates frame numbers to which a data operation (transmission or muting) is applied, and a duration for maintaining the instruction of the center eNB. Field 3 can have a Null state. This means that the data operation is performed for only 1 subframe after a predetermined N₀ frame from a point of time when a signal is received from the center eNB. Field 4 indicates transmission power information of data. Field 4 can have a Null state. In this case, the transmission power value is autonomously determined by each eNB. Field 5 indicates radio network temporary identifier (RNTI) information of a UE. Field 6 indicates the type of a DL DCI format. Field 7 indicates precoding information including transmission layer information applied for each resource unit within a resource region allocated to the corresponding UE. Field 7 is valid only if the information of field 6 indicates a DM-RS based DCI format and is omitted otherwise. Field 8 indicates CSI process index information applied to the corresponding UE. Field 8 is valid only if the information of field 6 indicates a DCI format corresponding to TM9 or TM10 and is omitted otherwise. Fields from field 9 correspond to fields of the DCI format indicated by field 6, and each field includes a Null state. If each of the fields from field 9 is Null, this means that there is no value instructed by the center eNB and thus each eNB has autonomy for the corresponding DCI field. The fields from field 4 are valid only if the information of field 2 indicates On and can be omitted otherwise. The order of the fields can be changed or some of the fields can be omitted. In this case, the frame number/time duration information of field 3 does not need to be reported for each UE and can be reported for each eNB.

1.3.2. Configuration of Data Transmission Information for Each Resource Unit Defined by Center eNB

FIG. 7(b) illustrates fields of data transmittable for each resource unit.

The center eNB may configure the following information for each resource unit for performing data transmission or data muting. Field 1 indicates a transmission point at which data transmission or data muting is actually performed. Field 2 indicates a data transmission status as one of {On, Off, Null}. Here, On means that there is data transmission instructed by the center eNB, and Off means that there is data muting instructed by the center eNB. In this case, if field 2 is Null, this means that autonomy is given to each eNB for data transmission in a corresponding resource unit. Field 3 indicates frame numbers to which a data operation (transmission or muting) is applied. Field 3 can have a Null state. This means that the data operation is performed after a predetermined N₀ frame from a point of time when a signal is received from the center eNB. Field 4 indicates transmission power information of data. Field 4 can have a Null state. In this case, the transmission power value is autonomously determined by each eNB. Field 5 indicates radio network temporary identifier (RNTI) information of a UE. Field 6 indicates the type of a DL DCI format. Field 7 indicates precoding information including transmission layer information applied in the corresponding resource unit. Field 7 is valid only if the information of field 6 indicates a DM-RS based DCI format and is omitted otherwise. Field 8 indicates CSI process index information used in the corresponding resource unit. Field 8 is valid only if the information of field 6 indicates a DCI format corresponding to TM9 or TM10 and is omitted otherwise. Fields from field 9 correspond to fields of the DCI format indicated by field 6 other than fields associated with resource allocation, and each field includes a Null state. If each of the fields from field 9 is Null, this means that there is no value instructed by the center eNB and thus each eNB has autonomy for the corresponding DCI field. The fields from field 4 are valid only if the information of field 2 indicates On and can be omitted otherwise. The order of the fields can be changed or some of the fields can be omitted. In this case, the frame number/time duration information of field 3 does not need to be reported for each UE and can be reported for each eNB. Further, in this case, resource index information can be reported using field 0. The resource index can be omitted when a data information list is transmitted according to the order of resource units.

1.4. Transmission of Data Transmission Information List

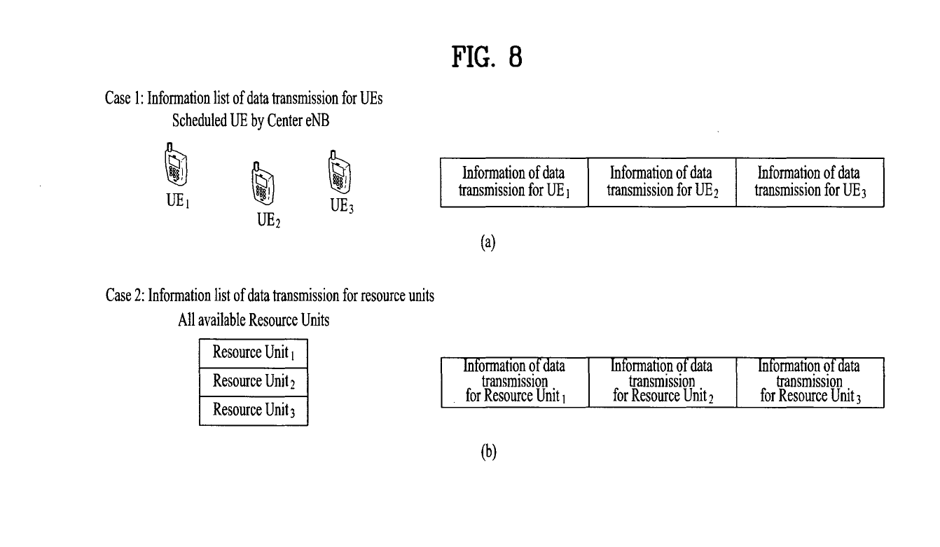

The center eNB may provide data transmission information configured for each UE or for each resource unit for performing data transmission or data muting, as one unit to each eNB in the form of a data transmission information list. In this case, the center eNB preconfigures CoMP groups for eNBs, and selects and transmits data transmission information for eNBs of a CoMP group to which a corresponding eNB belongs. In this case, the data transmission information does not always need to be transmitted to each eNB on a CoMP group basis. If data transmission information only for each eNB is transmitted, field 1 associated with a TP index can be omitted. In this case, the data transmission information for each UE is defined as one unit and a list of up to N units of information can be provided at a time depending on backhaul capacity. If the information is too large to be provided at a time, the information can be provided over a plurality of times. To this end, a flag for indicating whether a subsequent information list exists can be added. However, the data transmission information for each UE can include a case in which a specific UE is not designated due to a muting operation. FIG. 8 conceptually illustrates a data transmission information list configured for each UE or for each resource unit.

1.4.1. Application of Information List Configured Using Data Transmission Information for Each UE as Unit

Each eNB may determine whether a UE is allocated thereto using field 1 based on the data transmission information list and check fields from field 2 to apply non-Null values instructed by the center eNB if the UE is allocated thereto. After the above operation is completed, each eNB may autonomously determine optimal values for fields having Null values. If there are extra resources after resource allocation is performed according to the above operation, the eNB may additionally serve a UE having a high scheduling priority among UEs which are not present on the information list transmitted to the eNB but are servable by the eNB. In this case, if there is an operation instructed by the center eNB, the resources may be for a CoMP operation.

1.4.2. Application of Information List Configured Using Data Transmission Information for Each Resource Unit as Unit

Each eNB may determine whether a resource unit is allocated thereto using field 1 based on the data transmission information list and check fields from field 2 to apply non-Null values instructed by the center eNB if the resource unit is allocated thereto. After the above operation is completed, each eNB may autonomously determine optimal values for fields having Null values. If there are extra resources after resource allocation is performed according to the above operation, the eNB may additionally serve a UE having a high scheduling priority among UEs which are not present on the information list transmitted to the eNB but are servable by the eNB. In this case, if there is an operation instructed by the center eNB, the resources may be for a CoMP operation.

II. Examples of Applying CoMP

A detailed description is now given of the above-described signaling procedure according to the present invention using PS (point selection), PM (point muting) and CB (coordinated beamforming) for CoMP.

CoMP/Non-CoMP

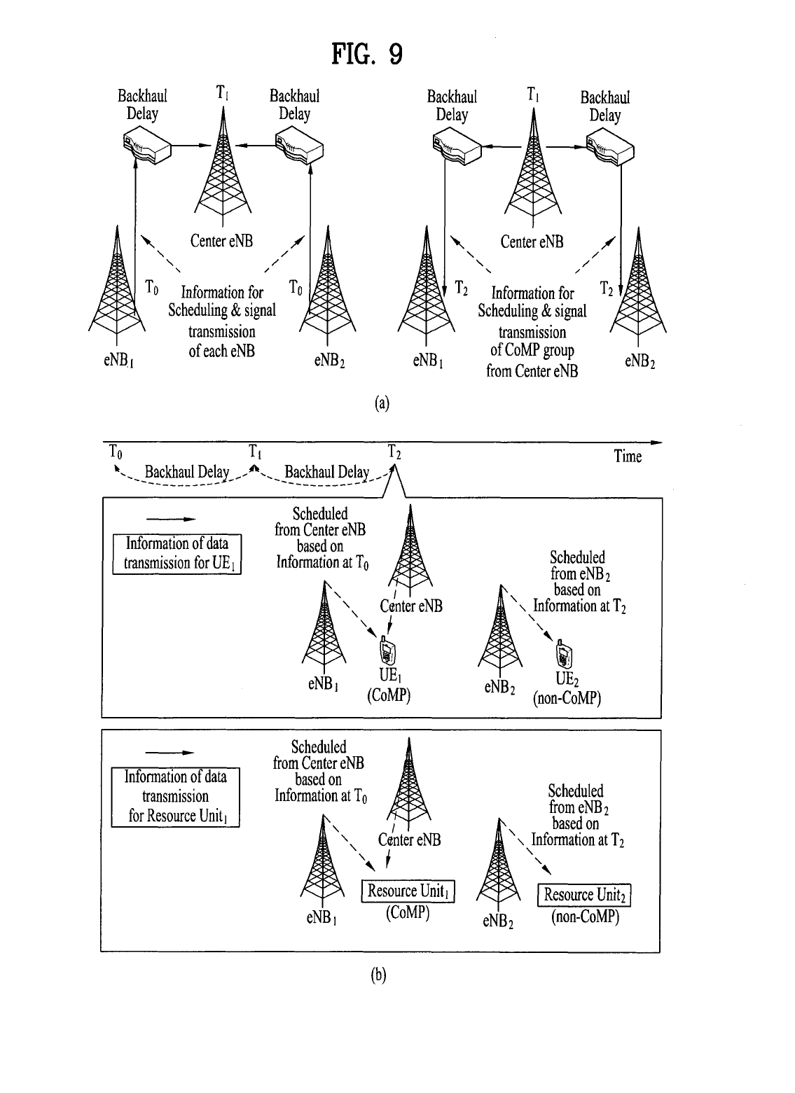

FIG. 9 illustrates a procedure for performing a data operation (data transmission or muting) on a UE or a resource unit for which the data operation is instructed on a data transmission information list received from a center eNB, and autonomously performing scheduling on a UE or a resource unit for which no data operation is instructed, by each eNB. Specifically, FIG. 9 illustrates that the center eNB acquires information from each eNB at T₀ and transmits a data transmission list to the eNB at T₁, and the eNB follows a data transmission scheme determined according to the information at T₀ for UE₁ or resource unit₁ for which a data operation is instructed on the data transmission information list, and autonomously performing scheduling on UE₂ or resource unit₂ for which no data operation is instructed, at T₂.

Point Selection

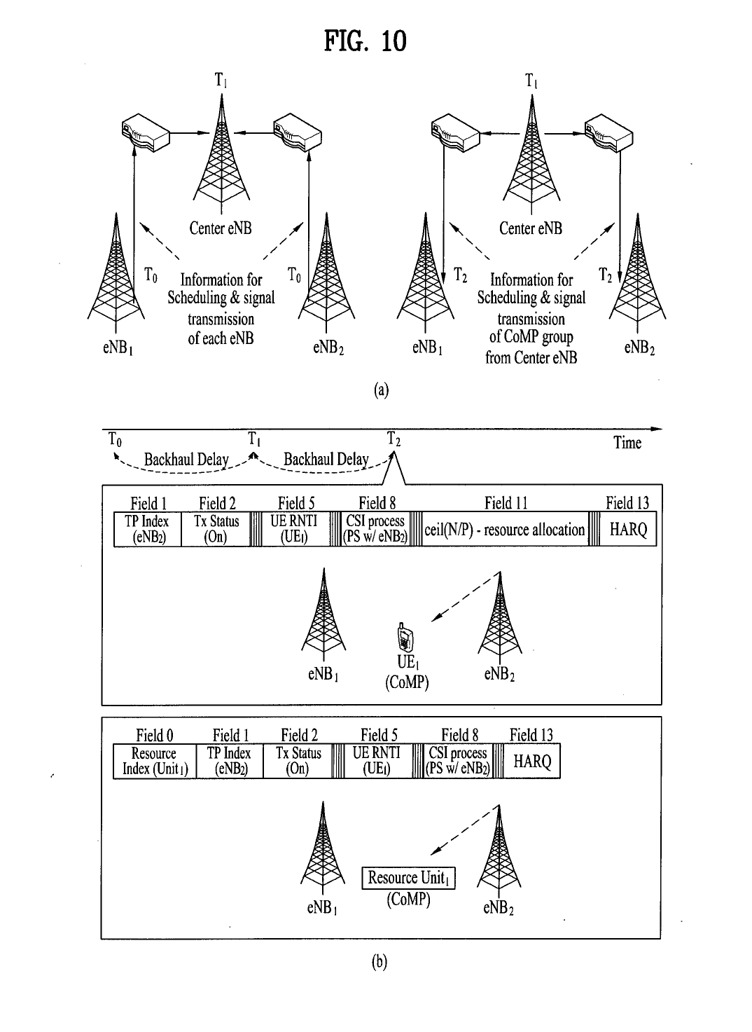

FIG. 10 exemplarily illustrates a PS operation for receiving data by an eNB having a high scheduling metric for a specific UE or a resource unit, as one of CoMP operations. In FIG. 10, for a UE (e.g., UE₁) or a resource unit (e.g., resource unit₁) for which a data operation (data transmission or muting) is instructed on a data transmission information list received from a center eNB, eNB₂ checks a data transmission point (e.g., eNB₂) of field 1, checks no muting operation in field 2, checks for a target UE in field 5, determines MCS and PMI according to a recent CSI based on a CSI process indicated by field 8, and transmits data for a HARQ process of field 13. In this case, if data transmission information for each UE is received, eNB₂ may additionally receive field 11 to acquire information about a resource region for performing PS. Here, among other fields having no instruction from the center eNB, some fields become invalid according to operation of the present invention and the other valid fields having no instructed values are known as Null. The values of the Null fields can follow preconfigured values (e.g., frame number), or autonomously determined by each eNB.

Point Muting

FIG. 11 exemplarily illustrates a PM operation for not transmitting signals other than CRS for a resource region in which a specific UE receives data, or a specific resource unit to reduce interference by some eNBs participating in a CoMP operation for the specific UE or the specific resource unit, as one of CoMP operations. In FIG. 11, for a UE (e.g., UE₁) or a resource unit (e.g., resource unit₁) for which a data operation (data transmission or muting) is instructed on a data transmission information list received from a center eNB, eNB₂ may check a data transmission point (e.g., eNB₂) of field 1, and check a muting operation in field 2 to perform the muting operation. In this case, if data transmission information for each UE is received, eNB₂ may additionally receive field 11 to acquire information about a resource region for performing muting. Here, among other fields having no instruction from the center eNB, some fields become invalid according to operation of the present invention and the other valid fields having no instructed values are known as Null. The values of the Null fields can follow preconfigured values (e.g., frame number), or autonomously determined by each eNB.

Coordinated Beamforming

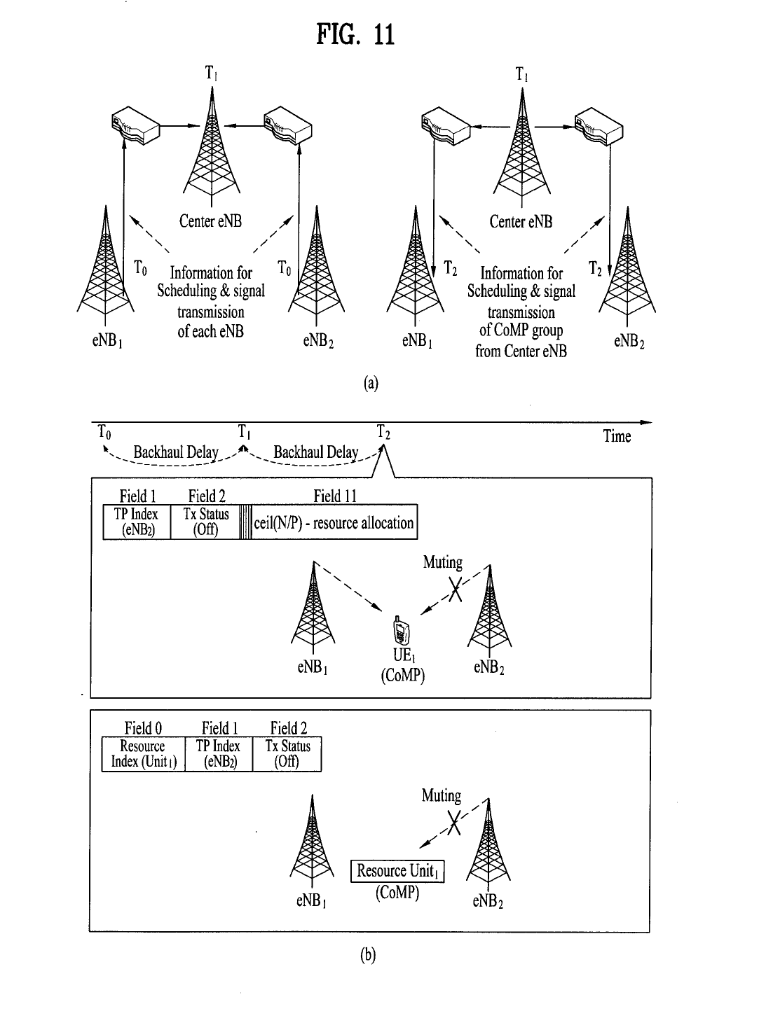

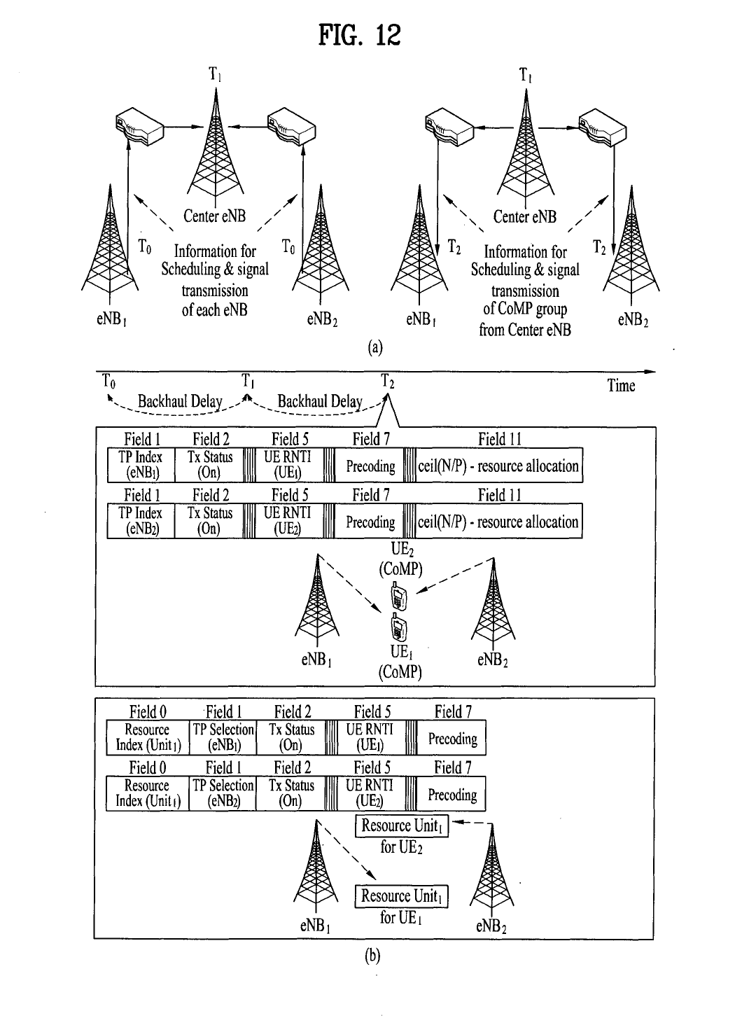

FIG. 12 exemplarily illustrates a CB operation for controlling a beam direction to reduce interference to a neighbor eNB when eNB transmits data for a specific UE or a resource unit, as one of CoMP operations. In FIG. 12, for a UE (e.g., UE₁/UE₂) or a resource unit (e.g., resource unit₁) for which a data operation (data transmission or muting) is instructed on a data transmission information list received from a center eNB, eNB₁ or eNB₂ checks a data transmission point (e.g., eNB₁/eNB₂) of field 1, checks no muting operation in field 2, checks for a target UE in field 5, and performs CB based on precoding information indicated by field 7.

In this case, the above precoding information can directly indicate a precoding matrix or indicate restrictions to determine a precoding matrix. In addition, if data transmission information for each UE is received, the corresponding eNB may additionally receive field 11 to acquire information about a resource region for performing CB. Here, among other fields having no instruction from the center eNB, some fields become invalid according to operation of the present invention and the other valid fields having no instructed values are known as Null. The values of the Null fields can follow preconfigured values (e.g., frame number), or autonomously determined by each eNB.

III. Operation for Determining Instruction of Center eNB by eNB

A description is now given of an operation for determining instructions of a center eNB by an eNB even when non-Null values are instructed on a data transmission information list transmitted from the center eNB, as another operation of the present invention.

3.1. Operation for Re-Determining Instruction of Data Transmission Information List of Center eNB by Specific eNB

It is assumed that each eNB receives the data transmission information list for UEs from the center eNB. At this time, it is also assumed that the center eNB instructs data transmission to a specific UE to a specific eNB. The above information is applied after a certain time due to NIB and thus the possibility that the specific eNB finds out a UE having an excellent scheduling metric is high if a backhaul delay has a large value. In this case, the corresponding eNB may serve the newly found UE without performing scheduling of the UE instructed by the center eNB.

The operation is performed for every resource unit (e.g., minimum CSI report resource unit) determined by the center eNB. That is, the center eNB should provide information about a scheduling metric of a UE selected for each resource unit, to each eNB, and the eNB may not follow the determination of the center eNB and autonomously perform scheduling and data transmission if a UE scheduling or data transmission scheme capable of achieving a higher scheduling metric than the scheduling metric notified from the center eNB for the corresponding resource unit is present. However, if a UE scheduling or data transmission scheme capable of achieving a higher scheduling metric is not present, the eNB follows the instructions of the center eNB in the corresponding resource unit. In this case, the center eNB may selectively give authority for re-determining the instructions of the data transmission information list, to each eNB through additional signaling.

3.2. Operation for Notifying CoMP Group to Each eNB by Center eNB

Each eNB receives information about eNBs with which a CoMP operation is performed, from the center eNB. The above information is used for fall back to a non-CoMP operation of all eNBs belonging to the corresponding group when a specific eNB goes against the CoMP operation in the future.

3.3. Operation for Re-Determining Instruction of Data Transmission Information List and then Notifying Result Thereof to Other eNBs within CoMP Group by Specific eNB

It is assumed that each eNB receives the data transmission information list from a center eNB. At this time, it is also assumed that the center eNB instructs data transmission to a specific UE to a specific eNB but the specific eNB re-determines the instruction. In this case, if the specific eNB does not follow the instruction of the center eNB related to a CoMP operation (i.e., the data transmission information list), eNBs belonging to the CoMP group to which the corresponding eNB belongs may determine that the CoMP operation is broken and individually perform a non-CoMP operation. Here, the specific eNB has duty to notify that the eNB does not follow the instruction. For example, the specific eNB may give an instruction through DCI or the like to the UE to which the center eNB instructs the eNB for data transmission in such a manner that the corresponding UE broadcasts in UL that the specific eNB does not follow the instruction. In this case, the center eNB should determine information such as RNTI of the UE, sequence initial value information of a UL reference signal, and UL resources in advance and provide the information to the eNBs of the CoMP group together with the data transmission information list. In addition, the eNBs of the CoMP group other than the specific eNB waits for a certain time in order to receive a UL signal. If a UL signal is received, the eNBs may perform a non-CoMP operation according to the received signal. Otherwise, if a UL signal is not received, the eNBs may perform a CoMP operation according to the data transmission information list received from the center eNB.

In the above description, the center eNB may be an arbitrary eNB participating in a CoMP operation.

IV. Signaling for CoMP—when Center eNB does not Exist

As another operation of the present invention, the present invention proposes a signaling method among a plurality of eNBs participating in CoMP without a center eNB in the above NIB environment.

A description is now given of an operation for determining whether a specific UE is a UE which needs a CoMP operation, i.e., CoMP UE, using RSRP (reference signal received power) values for neighbor cells reported by the specific UE. In general, a UE which needs a CoMP operation may be located at the boundary between a cell (e.g., eNB, transmission point (TP)) and a cell (hereinafter referred to as a cell boundary UE). As a method for determining the cell boundary UE, RSRP values for neighbor cells reported by a UE may be used. For example, if a specific UE has a certain threshold value compared to RSRP from a serving cell, e.g., RSRP within 10 dB, for any neighbor cell, the serving cell may define the corresponding UE as a CoMP UE.

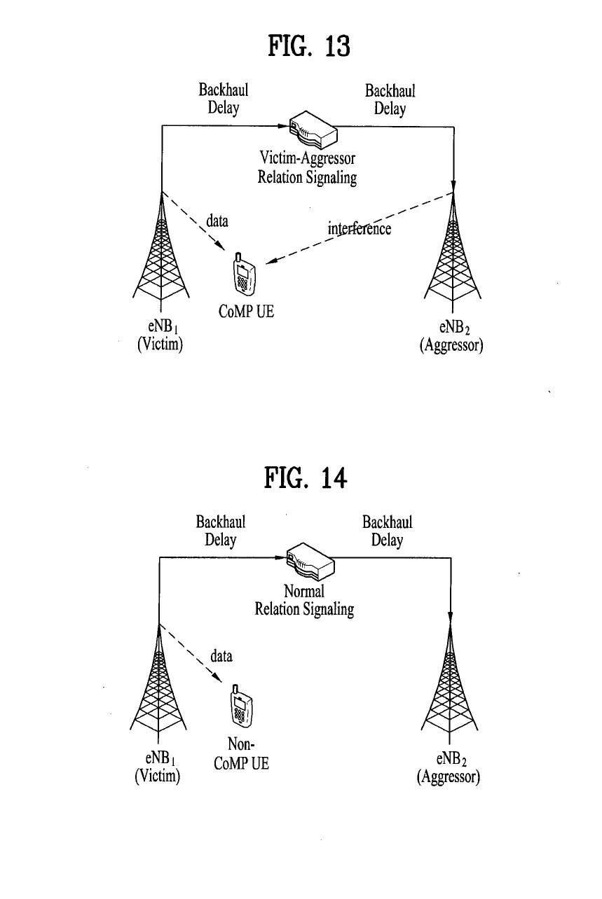

A description is now given of a victim-aggressor relation signaling scheme for notifying that a cell for serving a CoMP UE is a victim cell receiving interference and that neighbor cells are aggressor cells capable of provisionally giving interference, to the neighbor cells by the serving cell through NIB when or before service for the CoMP UE starts, if CoMP is performed between the cells (e.g., eNBs) through NIB. FIG. 13 illustrates signaling for notifying neighbor cells that they can be aggressor cells capable of provisionally giving interference, according to RSRP values in a procedure for configuring a CoMP UE when eNB₁ serves the CoMP UE. Here, since an aggressor cell is determined according to an RSRP value, the aggressor cell can be configured even when the aggressor cell does not currently transmit data. However, the aggressor cell is defined and valid at a point of time when service for the CoMP UE starts. For example, eNB₂ is signaled that eNB₂ is an aggressor cell, through NIB after eNB₁ schedules the CoMP UE.

A description is now given of a normal relation signaling scheme for notifying that pre-configured victim-aggressor relation signaling is no more valid, to neighbor cells by a cell for serving a CoMP UE when or before service for the CoMP UE ends, if CoMP is performed between the cells (e.g., eNBs) through NIB. FIG. 14 illustrates the normal relation signaling. eNB₂ can be recognized as an aggressor cell only during eNB₁ schedules the CoMP UE. In this case, if scheduling of the CoMP UE ends, signaling for making the pre-configured victim-aggressor relation signaling invalid as illustrated in FIG. 14 may be necessary. In FIG. 14, the normal relation signaling can be transmitted only after the victim-aggressor relation signaling is configured in advance.

A description is now given of a scheme for signaling previous information for supporting a CoMP operation to the aggressor cells by the victim cell through NIB when victim-aggressor relation signaling according to operation of the present invention is configured, if CoMP is performed between the cells (e.g., eNBs) through NIB. When the victim and aggressor relation is configured, since rapid information exchange is not easy due to restrictions of NIB, it can be preferable that the aggressor cells are in full charge of the CoMP operation and notify a result of the CoMP operation to the victim cell. In this case, the victim cell may preferably transmit information necessary for appropriate performance of the CoMP operation by the aggressor cell. For example, the information transmitted from the victim cell to the aggressor cells may include CSI information according to multiple CSI processes of the CoMP UE, scheduling metric information calculated using CSIs according to multiple CSI processes, average data rate information of the CoMP UE, precoding information, etc. The CSI information can be directly transmitted from the CoMP UE to the aggressor cells (e.g., eNB₂). For the CSI feedback to neighbor cells, eNB₂ should previous exchange RNTI of the CoMP UE and UL RS (e.g., DM-RS, SRS) configuration information with eNB₁.

A description is now given of a scheme for signaling information about a CoMP operation to the victim cell by the aggressor cells due to victim-aggressor relation signaling according to operation of the present invention, if CoMP is performed between the cells (e.g., eNBs) through NIB. The aggressor cells may determine a CoMP operation which is more advantageous to all UE scheduling metrics based on CSI information, UE scheduling metric information, UE average data rate information and precoding information received from the victim cell, and notify a result thereof to the victim cell. For example, the aggressor cells may notify power information allocated for each resource unit, whether to perform muting for each resource unit, precoding information for each resource unit, etc. to the victim cell. At this time, if a CoMP UE is capable of directly transmitting the CSI information to neighbor cells, i.e., aggressor cells, the aggressor cells may determine information about the CoMP operation and transmit the information to the victim cell in a 1-way manner. In this case, the UE average data rate information may be delivered by the victim cell to the aggressor cells through NIB. When the information about the CoMP operation is transmitted in a 1-way manner, although the UE average data rate information is not received at a specific point of time, the aggressor cells may determine the CoMP operation using previously received information. Since the average data rate is average information and is relatively insensitive to a time delay, a UE scheduling metric may be determined without much difficulty even in the above case.

A description is now given of an operation for sequentially performing CoMP operations between the victim cell and the aggressor cells if CoMP is performed between the cells (e.g., eNBs) through NIB. Specifically, the victim cell may notify the previous information for the CoMP operation sequentially to the aggressor cells based on priority. For example, the victim cell may give priority to a cell expected to give large interference based on RSRP values for the aggressor cells, and transmit the previous information to the corresponding cell first. In this case, a first-priority aggressor cell which has received the corresponding information transmits information about the CoMP operation to the victim cell. Then, the victim cell may deliver the information about the CoMP operation of the first-priority aggressor cell to a second-priority aggressor cell together with the previous information. In this manner, the victim cell may perform the CoMP operation sequentially with a plurality of neighboring aggressor cells.

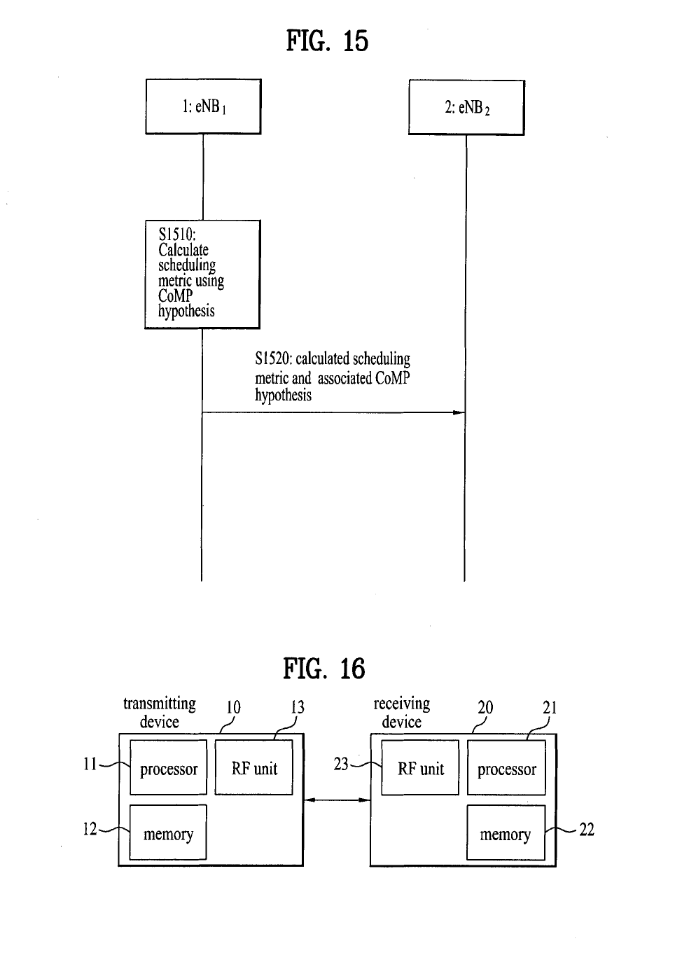

FIG. 15 illustrates operation according to an embodiment of the present invention. A wireless communication system according to an embodiment of the present invention may include eNB₁ 1, eNB₂ 2 neighboring to eNB₁ 1, and more eNBs to participate in a CoMP operation.

The eNB₁ 1 may calculate a utility metric of a UE(s) using a specific coordinated multiple point transmission and reception (CoMP) hypothesis (S1510). The specific CoMP hypothesis may include information about a neighbor eNB hypothesized to perform muting among neighbor eNB(s) participating in the CoMP operation together with the above eNB. The eNB₁ 1 may transmit the calculated utility metric and information about a CoMP hypothesis associated with the utility metric to the eNB₂ 2 (S1520).

The eNB₁ 1 may calculate the utility metric for every predetermined resource unit and transmit the calculated utility metric to the eNB₂ 2. In addition, if the eNB₁ 1 serves a plurality of UEs, the utility metric may be a value for all UEs served by the eNB₁ 1, or for a specific UE among the UEs served by the eNB₁ 1. Further, the utility metric is expressed as a bit string, and one state expressed by the bit string may represent that the eNB rejects the CoMP operation.

If the eNB₂ 2 is a subject for controlling the CoMP operation (e.g., center eNB), the eNB₂ 2 may determine a CoMP hypothesis indicating a CoMP operation to be scheduled, based on utility metrics received from other eNBs participating in the CoMP operation as well as the utility metric received from the eNB₁ 1. For example, the eNB₁ 1 may determine to actually schedule a CoMP operation indicated by a CoMP hypothesis corresponding to a highest utility metric. The determined scheduling information may be transmitted to the eNB₂ 2.

Meanwhile, if a subject for controlling the CoMP operation is not separately designated, the eNB₁ 1 may conduct negotiations with neighbor eNBs including the eNB₂ 2 for a CoMP operation to be actually scheduled and determine a CoMP hypothesis indicating the CoMP operation to be scheduled, using the utility metric and the associated CoMP hypothesis.

Embodiments of the present invention have been briefly described above with reference to FIG. 15. However, the embodiment related to FIG. 15 may alternatively or additionally include at least a part of the above-described embodiment(s).

FIG. 16 is a block diagram of a transmitting device 10 and a receiving device 20 configured to implement exemplary embodiments of the present invention. Referring to FIG. 16, the transmitting device 10 and the receiving device 20 respectively include radio frequency (RF) units 13 and 23 for transmitting and receiving radio signals carrying information, data, signals, and/or messages, memories 12 and 22 for storing information related to communication in a wireless communication system, and processors 11 and 21 connected operationally to the RF units 13 and 23 and the memories 12 and 22 and configured to control the memories 12 and 22 and/or the RF units 13 and 23 so as to perform at least one of the above-described embodiments of the present invention.

The memories 12 and 22 may store programs for processing and control of the processors 11 and 21 and may temporarily storing input/output information. The memories 12 and 22 may be used as buffers. The processors 11 and 21 control the overall operation of various modules in the transmitting device 10 or the receiving device 20. The processors 11 and 21 may perform various control functions to implement the present invention. The processors 11 and 21 may be controllers, microcontrollers, microprocessors, or microcomputers. The processors 11 and 21 may be implemented by hardware, firmware, software, or a combination thereof. In a hardware configuration, Application Specific Integrated Circuits (ASICs), Digital Signal Processors (DSPs), Digital Signal Processing Devices (DSPDs), Programmable Logic Devices (PLDs), or Field Programmable Gate Arrays (FPGAs) may be included in the processors 11 and 21. If the present invention is implemented using firmware or software, firmware or software may be configured to include modules, procedures, functions, etc. performing the functions or operations of the present invention. Firmware or software configured to perform the present invention may be included in the processors 11 and 21 or stored in the memories 12 and 22 so as to be driven by the processors 11 and 21.

The processor 11 of the transmitting device 10 is scheduled from the processor 11 or a scheduler connected to the processor 11 and codes and modulates signals and/or data to be transmitted to the outside. The coded and modulated signals and/or data are transmitted to the RF unit 13. For example, the processor 11 converts a data stream to be transmitted into K layers through demultiplexing, channel coding, scrambling and modulation. The coded data stream is also referred to as a codeword and is equivalent to a transport block which is a data block provided by a MAC layer. One transport block (TB) is coded into one codeword and each codeword is transmitted to the receiving device in the form of one or more layers. For frequency up-conversion, the RF unit 13 may include an oscillator. The RF unit 13 may include Nt (where Nt is a positive integer) transmit antennas.

A signal processing process of the receiving device 20 is the reverse of the signal processing process of the transmitting device 10. Under the control of the processor 21, the RF unit 23 of the receiving device 10 receives RF signals transmitted by the transmitting device 10. The RF unit 23 may include Nr receive antennas and frequency down-converts each signal received through receive antennas into a baseband signal. The RF unit 23 may include an oscillator for frequency down-conversion. The processor 21 decodes and demodulates the radio signals received through the receive antennas and restores data that the transmitting device 10 wishes to transmit.

The RF units 13 and 23 include one or more antennas. An antenna performs a function of transmitting signals processed by the RF units 13 and 23 to the exterior or receiving radio signals from the exterior to transfer the radio signals to the RF units 13 and 23. The antenna may also be called an antenna port. Each antenna may correspond to one physical antenna or may be configured by a combination of more than one physical antenna element. A signal transmitted through each antenna cannot be decomposed by the receiving device 20. A reference signal (RS) transmitted through an antenna defines the corresponding antenna viewed from the receiving device 20 and enables the receiving device 20 to perform channel estimation for the antenna, irrespective of whether a channel is a single RF channel from one physical antenna or a composite channel from a plurality of physical antenna elements including the antenna. That is, an antenna is defined such that a channel transmitting a symbol on the antenna may be derived from the channel transmitting another symbol on the same antenna. An RF unit supporting a MIMO function of transmitting and receiving data using a plurality of antennas may be connected to two or more antennas.

In embodiments of the present invention, a UE serves as the transmission device 10 on uplink and as the receiving device 20 on downlink. In embodiments of the present invention, an eNB serves as the receiving device 20 on uplink and as the transmission device 10 on downlink.

The transmitting device and/or the receiving device may be configured as a combination of one or more embodiments of the present invention.

The detailed description of the exemplary embodiments of the present invention has been given to enable those skilled in the art to implement and practice the invention. Although the invention has been described with reference to the exemplary embodiments, those skilled in the art will appreciate that various modifications and variations can be made in the present invention without departing from the spirit or scope of the invention described in the appended claims. For example, those skilled in the art may use each construction described in the above embodiments in combination with each other. Accordingly, the invention should not be limited to the specific embodiments described herein, but should be accorded the broadest scope consistent with the principles and novel features disclosed herein.

### INDUSTRIAL APPLICABILITY

The present invention may be used for a wireless communication apparatus such as a user equipment (UE), a relay and an eNB.

1-14. (canceled)

15. A method for transmitting information for a coordinated multiple point transmission and reception (CoMP) operation, the method performed by an evolved node B (eNB) and comprising:
calculating a utility metric associated with a specific CoMP hypothesis, wherein the specific CoMP hypothesis is related to a specific eNB; and
transmitting the calculated utility metric and information about the specific CoMP hypothesis, to a neighbor eNB,
wherein the information about the specific CoMP hypothesis is represented by a bit field.

16. The method according to claim 15, wherein the information about the specific CoMP hypothesis indicates the neighbor eNB hypothesized to perform predetermined power-transmission.

17. The method according to claim 15, wherein the information about the specific CoMP hypothesis is associated with transmission power of the neighbor eNB.

18. The method according to claim 15, wherein the utility metric is used by the neighbor eNB when scheduling a serving UE.

19. The method according to claim 15, wherein the utility metric indicates a value which the neighbor eNB is expected to have based on the specific CoMP hypothesis.

20. The method according to claim 15, wherein the information about the specific CoMP hypothesis comprises cell-identifier of the eNB.

21. The method according to claim 15, wherein the utility metric is calculated for every predetermined resource unit.

22. The method according to claim 15, wherein the utility metric is a value for all user equipments (UEs) served by the eNB.

23. The method according to claim 15, wherein the utility metric is a value for a representative UE among all UEs served by the eNB.

24. The method according to claim 15, wherein one state of the bit field represents that the eNB rejects the CoMP operation.

25. A method for transmitting information for a coordinated multiple point transmission and reception (CoMP) operation, the method performed by an evolved node B (eNB) and comprising:
receiving a utility metric associated with a specific CoMP hypothesis and information about the specific CoMP hypothesis from a neighbor eNB participating in the CoMP operation, wherein the specific CoMP hypothesis is related to a specific eNB;
scheduling the CoMP operation based on the received utility metric and the received information about the specific CoMP hypothesis; and
transmitting a result of the scheduling to the neighbor eNB,
wherein the information about the specific CoMP hypothesis is represented by a bit field.

26. The method according to claim 25, wherein the information about the specific CoMP hypothesis indicates the neighbor eNB hypothesized to perform predetermined power-transmission.

27. The method according to claim 25, wherein the information about the specific CoMP hypothesis is associated with transmission power of the neighbor eNB.

28. The method according to claim 25, wherein the utility metric is used by the neighbor eNB when scheduling a serving UE.

29. The method according to claim 25, wherein the utility metric indicates a value which the neighbor eNB is expected to have based on the specific CoMP hypothesis.

30. The method according to claim 25, wherein the information about the specific CoMP hypothesis comprises cell-identifier (ID)(s) of the neighbor eNB.

31. The method according to claim 25, wherein the utility metric is calculated for every predetermined resource unit.

32. The method according to claim 25, wherein the utility metric received from corresponding neighbor eNB is a value for all user equipments (UEs) served by the corresponding neighbor eNB.

33. The method according to claim 25, wherein the utility metric received from corresponding neighbor eNB is a value for a representative UE among all UEs served by the corresponding neighbor eNB.

34. The method according to claim 25, wherein one state of the bit field represents that a corresponding neighbor eNB rejects the CoMP operation.

35. An evolved node B (eNB) configured to transmit information for a coordinated multiple point transmission and reception (CoMP) operation, the eNB comprising:
a radio frequency (RF) unit; and
a processor configured to control the RF unit,
wherein the processor is configured to calculate a utility metric associated with a specific CoMP hypothesis, wherein the specific CoMP hypothesis is related to a specific eNB, and transmit the calculated utility metric and information about the specific CoMP hypothesis, to a neighbor eNB, and
wherein the information about the specific CoMP hypothesis is represented by a bit field.

36. An evolved node B (eNB) configured to transmit information for a coordinated multiple point transmission and reception (CoMP) operation, the eNB comprising:
a radio frequency (RF) unit; and
a processor configured to control the RF unit,
wherein the processor is configured to receive a utility metric associated with using a specific CoMP hypothesis and information about the specific CoMP hypothesis from a neighbor eNB participating in the CoMP operation, wherein the specific CoMP hypothesis is related to a specific eNB, schedule the CoMP operation based on the received utility metric and the information about the specific CoMP hypothesis, and transmit a result of scheduling to the neighbor eNB, and
wherein the information about the specific CoMP hypothesis is represented by a bit field.
